(19) United States
(12) Patent Application Publication
(10) Pub. No.: US 2016/0210320 A1
(43) Pub. Date: Jul. 21, 2016

(54) LOG ACQUISITION MANAGEMENT PROGRAM, LOG ACQUISITION MANAGEMENT DEVICE, AND LOG ACQUISITION MANAGEMENT METHOD

(71) Applicant: FUJITSU LIMITED, Kawasaki-shi (JP)

(72) Inventor: Yasunori Suzumura, YOKOHAMA (JP)

(73) Assignee: FUJITSU LIMITED, Kawasaki-shi (JP)

(21) Appl. No.: 14/990,361

(22) Filed: Jan. 7, 2016

(30) Foreign Application Priority Data
Jan. 16, 2015 (JP) 2015-006536

(51) Int. Cl. G06F 17/30

(52) U.S. Cl. CPC G06F 17/30342

(57) ABSTRACT

A non-transitory computer-readable storage medium storing therein a log acquisition management program for causing a computer to execute a process includes storing, in a first storage, identification information on first information processing device included in a plurality of information processing devices that are used for execution of a single application, in association with information indicating that a log has not been acquired, when executing first log acquisition processing and when the log has not been acquired from the first information processing device, and when executing second log acquisition processing, which is new log acquisition processing, after the first log acquisition processing has been executed, and when a log has been acquired from the first information processing device, acquiring also a log of a past period preceding a log acquisition target period of the second log acquisition processing from the first information processing device.

### CROSS-REFERENCE TO RELATED APPLICATION

This application is based upon and claims the benefit of priority of the prior Japanese Patent Application No. 2015-006536, filed on Jan. 16, 2015, the entire contents of which are incorporated herein by reference.

### FIELD

The present invention relates to a log acquisition management program, a log acquisition management device, and a log acquisition management method.

### BACKGROUND

A provider (also referred to hereinbelow as service provider) providing services to a user, for example, creates a business system for realizing the provision of services. The provider sometimes uses, for example, a PaaS (Platform as a Service) which is provided by a provider (also referred to hereinbelow as cloud provider) providing the cloud computing services.

The PaaS is a service mode which is different from an IaaS (Infrastructure as a Service), which provides hardware resources, such as physical machines (virtual machines), and provides a platform function (platform) such as middleware for operating the software. More specifically, the cloud provider provides an application interface (API) and a DBMS (Database Management System) to a PaaS contractant. The service provider using the PaaS creates a business system by using the platform provided from the cloud provider and provides services to the user.

Further, in the PaaS, each physical machine operating to provide the platform, for example, outputs a log to a predetermined storage unit (also referred to hereinbelow as “data storage”). By accessing the data storage to which the logs have been output, the service provider acquires the logs relating to the physical machine providing the platform. As a result, the service provider can monitor the physical machine providing the platform (see, for example, Patent Documents 1 and 2).
Patent Document 1: Japanese Laid-open Patent Publication No. H3-024843.
Patent Document 2: Japanese Laid-open Patent Publication No. 2004-295303.

### SUMMARY

In such a PaaS, the cloud provider sometimes does not provide to the service provider the information relating to the physical machines which operates to provide the platform. In this case, the service provider is not able to determine whether the acquisition of logs can be performed for all of the physical machines for which log acquisition is needed. As a result, the service provider can cause the occurrence of a log acquisition failure.

According to an aspect of the embodiments, a non-transitory computer-readable storage medium storing therein a log acquisition management program for causing a computer to execute a process includes storing, in a first storage, identification information on first information processing device included in a plurality of information processing devices that are used for execution of a single application, in association with information indicating that a log has not been acquired, when executing first log acquisition processing and when the log has not been acquired from the first information processing device, the first log acquisition processing being a processing acquiring logs from the plurality of information processing devices and collecting the acquired logs in a second storage, and when executing second log acquisition processing, which is new log acquisition processing, after the first log acquisition processing has been executed, and when a log has been acquired from the first information processing device, acquiring also a log of a past period preceding a log acquisition target period of the second log acquisition processing from the first information processing device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates the entire configuration of the information processing system.

FIG. 2 illustrates a specific example explaining the acquisition of logs by a monitoring device.

FIG. 3 depicts the hardware configuration of the monitoring device.

FIG. 4 is a functional block diagram of the monitoring device depicted in FIG. 3.

FIG. 5 is a flowchart diagram illustrating in general the log acquisition processing of the first embodiment.

FIG. 6 is a flowchart illustrating the details of the log acquisition management processing in the first embodiment.

FIG. 7 is a flowchart illustrating the details of the log acquisition management processing in the first embodiment.

FIG. 8 is a flowchart illustrating the details of the log acquisition management processing in the first embodiment.

FIG. 9 illustrates the details of the log acquisition management processing in the first embodiment.

FIG. 10 illustrates the details of the log acquisition management processing in the first embodiment.

FIG. 11 illustrates the details of the log acquisition management processing in the first embodiment.

FIG. 12 illustrates the details of the log acquisition management processing in the first embodiment.

FIG. 13 illustrates the details of the log acquisition management processing in the first embodiment.

FIG. 14 illustrates the details of the log acquisition management processing in the first embodiment.

FIG. 15 illustrates the details of the log acquisition management processing in the first embodiment.

FIG. 16 illustrates the details of the log acquisition management processing in the first embodiment.

FIG. 17 illustrates the details of the log acquisition management processing in the first embodiment.

FIG. 18 illustrates the details of the log acquisition management processing in the first embodiment.

FIG. 19 illustrates the details of the log acquisition management processing in the first embodiment.

FIG. 20 illustrates the details of the log acquisition management processing in the first embodiment.

FIG. 21 illustrates the details of the log acquisition management processing in the first embodiment.

FIG. 22 illustrates the details of the log acquisition management processing in the first embodiment.

FIG. 23 illustrates the details of the log acquisition management processing in the first embodiment.

FIG. 24 illustrates the details of the log acquisition management processing in the first embodiment.

FIG. 25 illustrates the details of the log acquisition management processing in the first embodiment.

FIG. 26 illustrates the details of the log acquisition management processing in the first embodiment.

FIG. 27 illustrates the details of the log acquisition management processing in the first embodiment.

FIG. 28 illustrates the details of the log acquisition management processing in the first embodiment.

FIG. 29 illustrates the details of the log acquisition management processing in the first embodiment.

FIG. 30 illustrates the details of the log acquisition management processing in the first embodiment.

FIG. 31 illustrates the details of the log acquisition management processing in the first embodiment.

FIG. 32 illustrates the details of the log acquisition management processing in the first embodiment.

### DESCRIPTION OF EMBODIMENTS

[Configuration of Information Processing System]

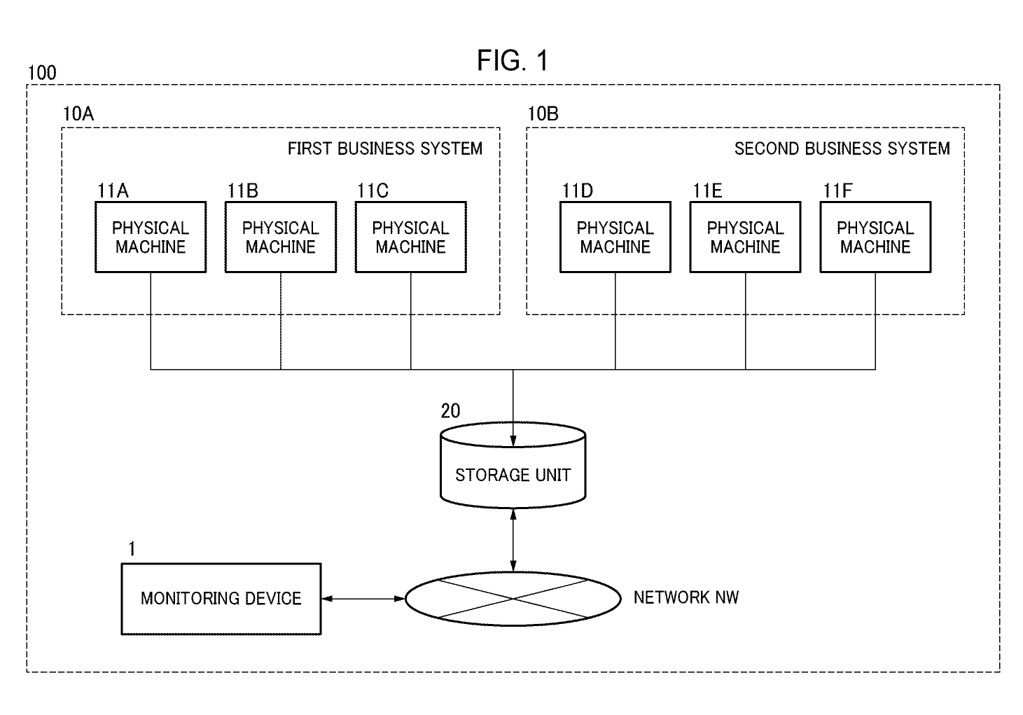

FIG. 1 illustrates the entire configuration of the information processing system. An information processing system 100 depicted in FIG. 1 has a physical machine 11A, a physical machine 11B, and a physical machine 11C operating as a business system 10A (also referred to hereinbelow as “first business system 10A”) for providing services to a user. The information processing system 100 depicted in FIG. 1 also has physical machines 11D, 11E, and 11F operating as a business system 10B (also referred to hereinbelow as “second business system 10B”) which performs the processing of acquiring the backup of the business system 10A. The physical machines 11A, 11B, 11C, 11D, 11E, and 11F are all together referred to hereinbelow simply as “physical machine 11”.

The information processing system 100 depicted in FIG. 1 also has a storage unit 20 into which the physical machines 11A, 11B, 11C, 11D, 11E, and 11F output logs, and a monitoring device 1 that accesses the storage unit 20 via a network NW. The network NW is, for example, the Internet.

In the information processing system 100 depicted in FIG. 1, the physical machines 11A, 11B, 11C, 11D, 11E, and 11F and the storage unit 20 are devices of the abovementioned cloud provider. In the information processing system 100 depicted in FIG. 1, the monitoring device 1 is a device of the abovementioned service provider.

The monitoring device 1 is, for example, a physical machine and acquires logs of the physical machine 11A, etc., output to the storage unit 20. The monitoring device 1 also monitors the physical machine 11A, etc., on the basis of the logs acquired from the storage unit 20.

In the example depicted in FIG. 1, the first business system 10A and the second business system 10B are each constituted by three physical machines, but the number of physical machines may be changed according to the increase/decrease in processing load or the like. More specifically, when the cloud provider increases the processing load of the first business system 10A, for example, a new physical machine is caused to operate as part of the first business system 10A. Thus, in this case, the first business system 10A in the example depicted in FIG. 1 is constituted by four or more physical machines. Meanwhile, when the cloud provider decreases the processing load of the first business system 10A, for example, reconfiguration can be performed such that the number of physical machines operating as part of the first business system 10A becomes two or less. As a result, the cloud provider can efficiency use the resources such as physical machines.

[Acquisition of Logs by Monitoring Device]

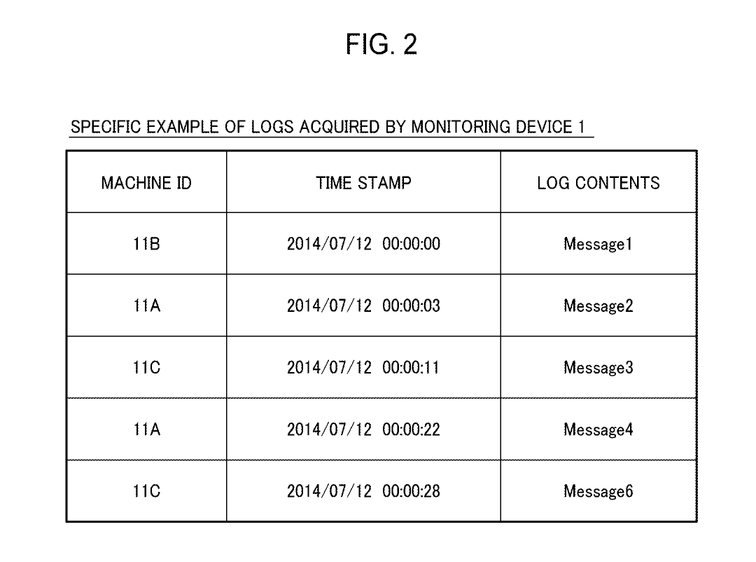

The acquisition of logs by the monitoring device 1 will be described hereinbelow. FIG. 2 illustrates a specific example explaining the acquisition of logs by a monitoring device. Described hereinbelow is the case in which the physical machines 11A, 11B, and 11C depicted in FIG. 1 output logs to the storage unit 20. In the example depicted in FIG. 2, the monitoring device 1 has accessed the storage unit 20 and acquired the logs at 0 h, 0 min, 30 sec on Jul. 12, 2014.

The items of the logs depicted in FIG. 2 include a MACHINE ID identifying the physical machine outputting the log, a TIME STAMP indicating the time at which the log has been output, and LOG CONTENTS which are the log contents. More specifically, in the example depicted in FIG. 2, in the information with the MACHINE ID of “11B”, “2014/07/12 00:00:00” is set in the TIME STAMP and “Message 1” is set in the LOG CONTENTS. The explanation relating to other types of information in FIG. 2 is omitted. Further, “11A”, “11B”, and “11C” which have been set in MACHINE ID in FIG. 2 correspond to the physical machines 11A, 11B, and 11C described with reference to FIG. 1.

In the physical machines mentioned herein, a processing delay can occur due to the increase in processing load, or the like. In this case, the output of log from each physical machine to the storage unit 20 can be delayed. More specifically, in the example depicted in FIG. 2, such a delay corresponds to the case in which the physical machine 11B outputs the log with the TIME STAMP of “2014/07/12 00:00:25” to the storage unit 20 at 0 h, 0 min, 35 sec on Jul. 12, 2014. In this case, when the monitoring device 1 accesses the storage unit 20 at 0 h, 0 min, 30 sec on Jul. 12, 2014, the log with the TIME STAMP of “2014/07/12 00:00:25” is not able to be acquired.

Further, when the monitoring device 1 is not able to acquire the information relating to the physical machine 11B (information relating to the operation state of the physical machine 11B), the monitoring device 1 is not able to recognize the processing delay generated in the physical machine 11B. Therefore, even when a log output with a delay to the storage unit 20 is present, the monitoring device 1 does not perform the reacquisition of the log and the log acquisition failure can be occurred.

Further, depending on the contents of the contract between the cloud provider and service provider, in some cases, the monitoring device 1 is not able to delete the log output to the storage unit 20. In such a case, the monitoring device 1 needs to acquire logs from the storage unit 20 under a designated condition, but in order to prevent the same log from being acquired repeatedly, log acquisition in a wide range is not able to be performed. More specifically, for example, the monitoring device 1 is not able to acquire logs under the designated condition of “all of the logs having the TIME STAMP indicating a time preceding a certain time”. Therefore, the monitoring device 1 is not able to prevent a log acquisition failure caused by the spread of conditions when the logs are acquired.

Accordingly, in the present embodiment, when the monitoring device 1 does not acquire logs from the first physical machine (also referred to hereinbelow as “first information processing device”) included in the plurality of physical machines 11, the identification information on the first information processing device and information indicating that a log is not able to be acquired are stored in association with each other. When the monitoring device 1 thereafter acquires the log from the first information processing device, logs of the past periods (also referred to hereinbelow simply as “past logs”) are acquired from the first information processing device. As a result, the monitoring device 1 prevents the acquisition failure of the log to be acquired.

[Hardware Configuration of Monitoring Device]

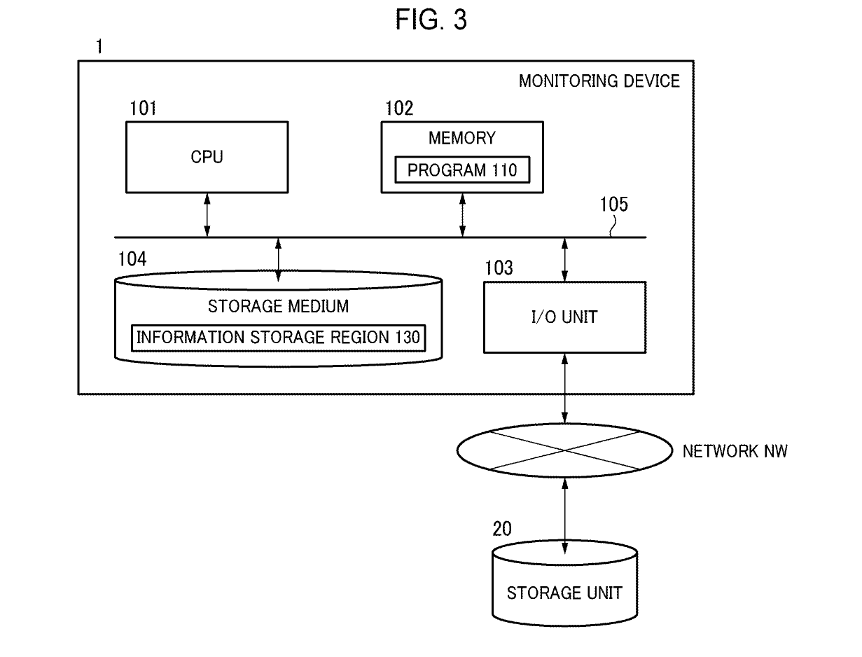

The hardware configuration of the monitoring device 1 will be explained hereinbelow. FIG. 3 depicts the hardware configuration of the monitoring device. The monitoring device 1 has a CPU 101, which is a processor, a memory 102, an external interface (I/O unit) 103 for accessing the storage unit 20 via a network NW, and a storage medium 104. The units are connected to each other by a bus 105.

The storage medium 104 stores a program 110 (also referred to hereinbelow as “log acquisition management program”) for executing the processing (also referred to hereinbelow as “log acquisition management processing”) of managing the log acquisition in a program storage region (not depicted in the figure) in the storage medium 104. The CPU 101 loads the program 110 from the storage medium 104 into the memory 102 when the program 110 is to be executed, and performs the log acquisition management processing in cooperation with the program 110, as depicted in FIG. 3. The storage medium 104 also has, for example, an information storage region 130 (also referred to hereinbelow as “storage section 130” or “second storage section 130”) which stores information to be used when performing the log acquisition management processing.

[Functions of Monitoring Device]

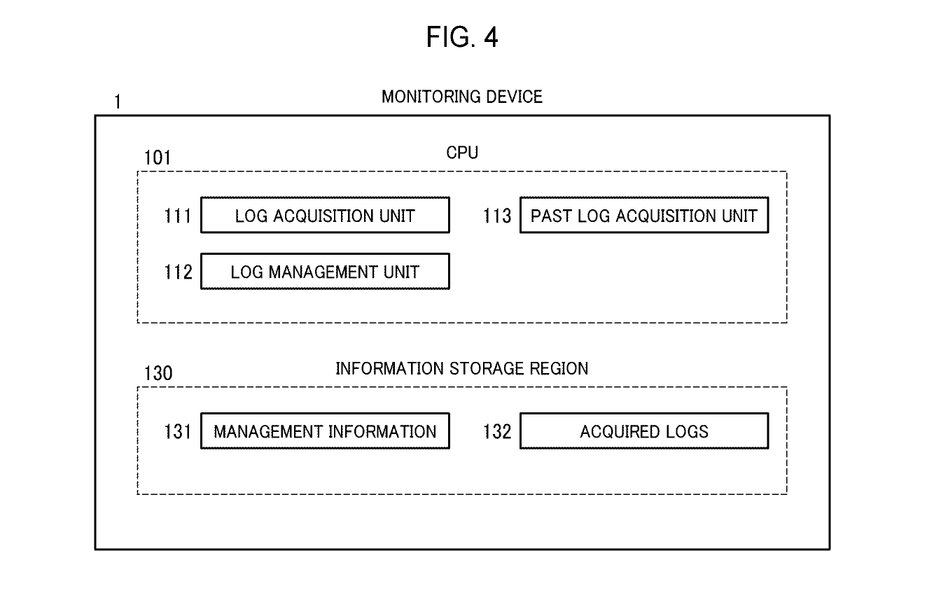

FIG. 4 is a functional block diagram of the monitoring device depicted in FIG. 3. The CPU 101 of the monitoring device 1 operates as a log acquisition unit 111, a log management unit 112, and a past log acquisition unit 113 in cooperation with the program 110. Management information 131 and acquired logs 132 are stored in the information storage region 130. The log acquisition unit 111 and the past log acquisition unit 113 are also referred to hereinbelow as “processing units”.

The log acquisition unit 111 executes the log acquisition processing (also referred to hereinbelow as “first log acquisition processing”) of acquiring logs from a plurality of physical machines 11 which are used for executing a single application, and collect the acquired logs 132 in the information storage region 130. More specifically, the log acquisition unit 111 may access the storage unit 20, for example, at a regular timing, such as once each minute, and store the acquired logs 132 in the information storage region 130. A specific example in which the log acquisition unit 111 acquires the logs will be explained hereinbelow.

The log management unit 112 determines whether or not logs have been acquired from all of the physical machines included in the plurality of physical machines 11, for example, when the log acquisition unit 111 executes the first log acquisition processing. Further, for example, when the log has not been acquired from the first physical machine included in the physical machines 11, the log management unit 112 stores the identification information of the first physical machine and the information to the effect that the log has not been acquired in association with each other as part of the management information 131 in the information storage region 130. The log management unit 112 stores the management information 131 in the information storage region (also referred to hereinbelow as “first storage section”) which is included in the information storage region 130. The log management unit 112 may store the management information 131 in the information storage region which is different from the information storage region 130.

Then, the log acquisition unit 111, for example, executes the second log acquisition processing which is new log acquisition processing after the first log acquisition processing. When the log (the past log) is acquired from the first physical machine, from which the log has not been acquired in the first log acquisition processing, when the second log acquisition processing is executed, the past log acquisition unit 113, for example, stores the acquired past logs in the information storage region 130. In this case, the past log acquisition unit 113, for example, acquires logs of a period preceding the log acquisition target period of the second log acquisition processing.

### First Embodiment

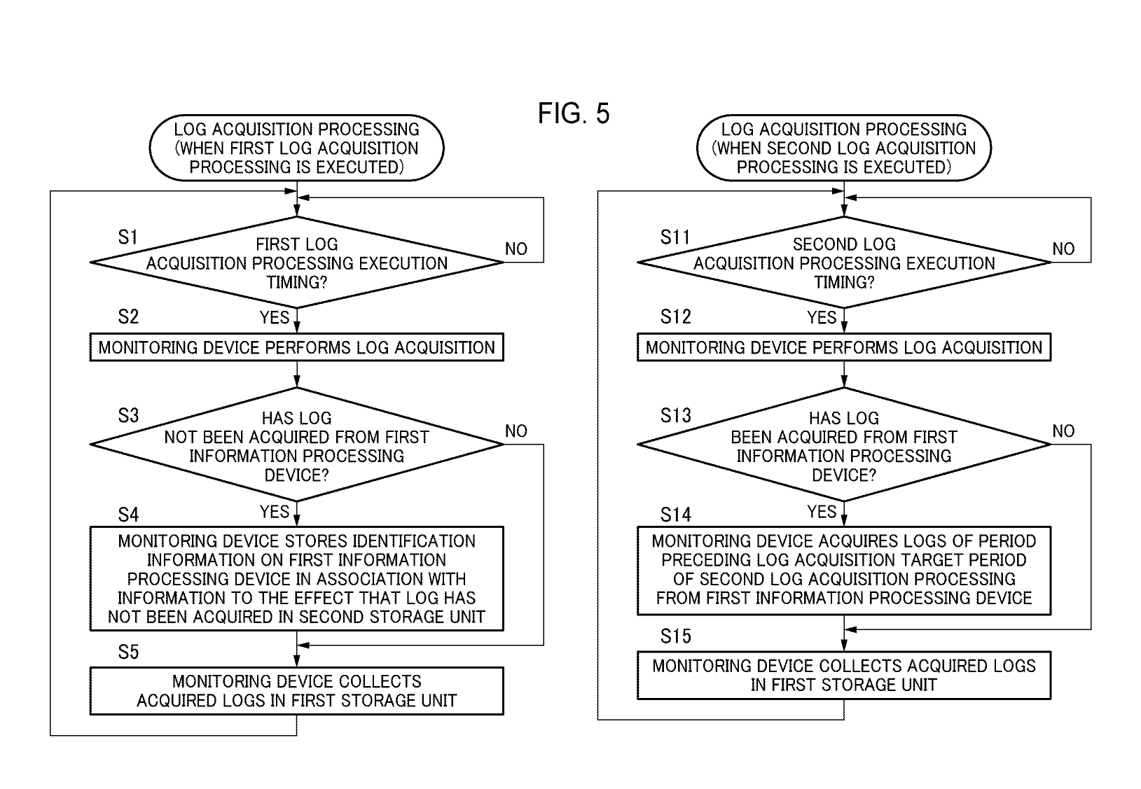

The first embodiment is explained hereinbelow. FIG. 5 is a flowchart diagram illustrating in general the log acquisition processing of the first embodiment. The flowchart on the left side in FIG. 5 illustrates the log acquisition management processing in the case in which the monitoring device 1 executes the first log acquisition processing, and the flowchart on the right side in FIG. 5 illustrates the log acquisition management processing in the case in which the monitoring device 1 executes the second log acquisition processing.

As depicted in the flowchart on the left side in FIG. 5, the monitoring device 1 waits until the execution timing of the first log acquisition processing (NO in S1). Once the execution timing of the first log acquisition processing is reached (YES in S1), the monitoring device 1 accesses the storage unit 20 and performs log acquisition (S2). Thus, in this case, the monitoring device 1 executes the first log acquisition processing.

When the log output by the first physical machine included in the plurality of physical machines 11 has not been acquired (YES in S3), the monitoring device 1 stores the identification information of the first physical machine in association with the information to the effect that the log has not been acquired in the first storage section (S4). Meanwhile, where the logs output by all of the physical machines included in the plurality of physical machines 11 have been acquired (NO in S3), the monitoring device 1 does not store information such as identification information.

Thus, in the first log acquisition processing, when the log output from the first physical machine from which the logs have been continuously acquired in the past, was not able to be acquired, the monitoring device 1 determines that a processing delay might occur in the first physical machine. In order to prevent the log acquisition failure, the monitoring device 1 stores information needed for performing the acquisition of the logs of the first physical machine retrospectively, as will be described hereinbelow.

Then, the monitoring device 1 collects the logs acquired in S2 in the information storage region 130 (S5).

Then the monitoring device 1 waits, for example, until the execution timing of the second log acquisition processing according to the flowchart on the right side in FIG. 5 (NO in S11). The second log acquisition processing is a new log acquisition processing executed after the first log acquisition processing has been executed. When the execution timing of the second log acquisition processing is reached (YES in S11), the monitoring device 1 accesses the storage unit 20 and performs log acquisition (S12). Thus, in this case, the monitoring device 1 executes the second log acquisition processing.

Then, the monitoring device 1 determines whether or not a log has been acquired from the first physical machine from which the log was not able to be acquired in S2 (S13). When the log has been acquired from the first physical machine (YES in S13), the monitoring device 1 acquires the logs of a period preceding the log acquisition target period of the second log acquisition processing from the first physical machine (S14). Meanwhile, when the log has not been acquired from the first physical machine (NO in S13), the monitoring device 1 does not acquire the past logs.

Thus, when the log has been acquired from the first physical machine from which the log was not able to be acquired in S2, the monitoring device 1 determines that a factor (for example, an increase in processing load) delaying the output of logs in the first physical machine has been eliminated. Accordingly, the monitoring device 1 in the present embodiment starts the acquisition with respect to the logs of the past period (a period preceding the period in which the log has not been acquired in S2) in response to the acquisition of the logs from the first physical machine. As a result, the monitoring device 1 can retrospectively acquire the logs that were not able to be acquired in the past and can prevent the occurrence of a log acquisition failure.

Then, the monitoring device 1 collects the logs acquired in S12 and the logs acquired in S14 in the information storage region 130 (S15).

Thus, according to the first embodiment, where a log has not been acquired from the first physical machine when the first log acquisition processing was executed, the first monitoring device 1 stores the identification information on the first physical machine in association with the information to the effect that the log has not been acquired. Where the log has been acquired from the first physical machine when the second log acquisition processing, which was new log acquisition processing, was executed, the monitoring device 1 acquires also the logs of the period preceding the log acquisition target period of the second log acquisition processing from the first physical machine. As a result, the monitoring device 1 can prevent the occurrence of a log acquisition failure with respect to the logs that have been output by the plurality of physical machines 11.

### Detailed Description of the First Embodiment

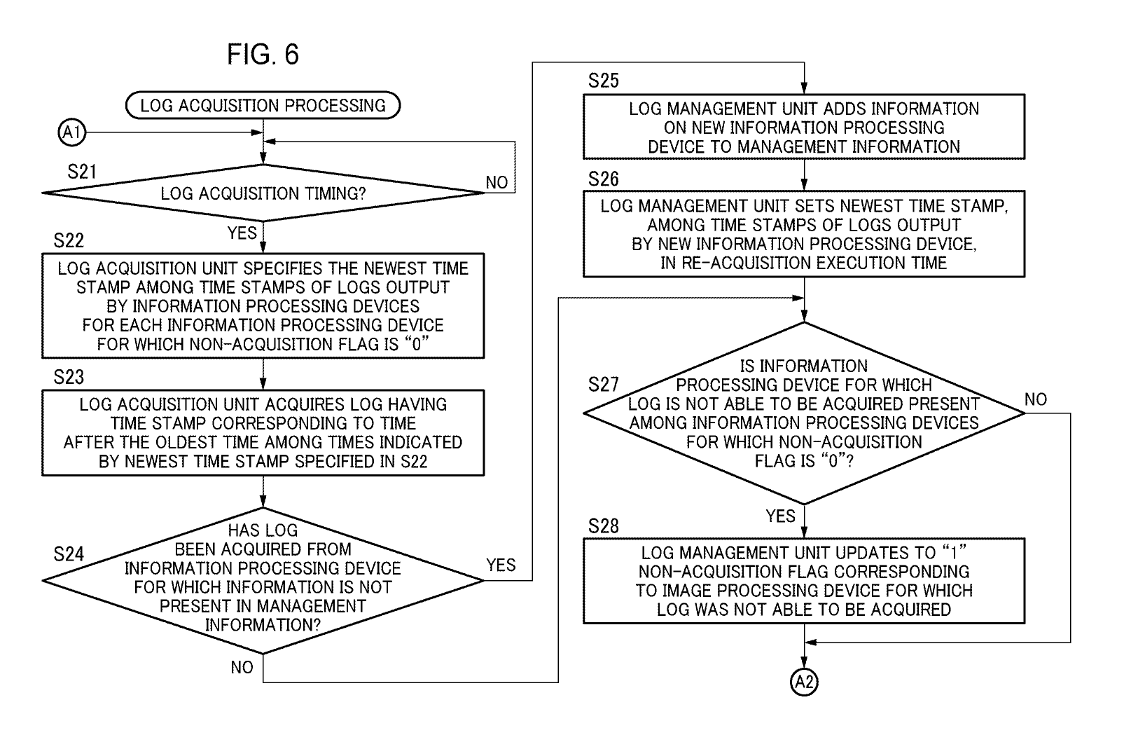

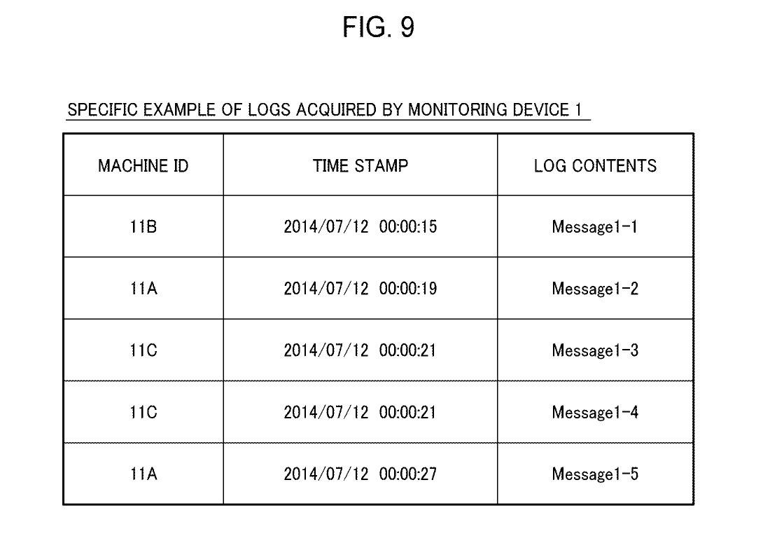

The first embodiment will be described hereinbelow in greater detail. FIGS. 6 to 8 are flowcharts illustrating the details of the log acquisition management processing in the first embodiment. FIGS. 9 to 32 illustrate the details of the log acquisition management processing in the first embodiment. The log acquisition management processing illustrated by FIGS. 6 to 8 will be described hereinbelow in details with reference to FIGS. 9 to 32. The first log acquisition processing and second log acquisition processing described with reference to FIG. 5 or the like will be together referred to hereinbelow as log acquisition processing. In the explanation below, it is assumed that the log acquisition unit 111 has been continuously acquiring the logs from the physical machines 11A, 11B, and 11C before the acquisition of the logs depicted in FIG. 9.

Initially, the log acquisition unit 111 of the monitoring device 1 waits until the execution timing of log acquisition processing (NO in S21). When the execution timing of the log acquisition processing is thereafter reached (YES in S21), the log acquisition unit 111 refers to the acquired logs 132 stored in the information storage region 130 (S22).

Then, the log acquisition unit 111 specifies the most recent TIME STAMP among the TIME STAMPS of the acquired logs 132 for each physical machine 11 for which the NON-ACQUISITION FLAG included in the management information 131 is “0” (S22). A specific example of the logs and management information 131 is explained hereinbelow.

FIG. 9 illustrates a specific example of logs acquired by the monitoring device 1. The logs depicted in FIG. 9 have items, for example, the same as those explained with reference to FIG. 2. More specifically, among the logs depicted in FIG. 9, the log with the MACHINE ID of “11B” has “2014/07/12 00:00:15” as the TIME STAMP and “Message 1-1” in the LOG CONTENTS. The explanation relating to other types of information in FIG. 9 is omitted. The logs depicted in FIG. 9 represent acquisition results relating to the case in which logs with the TIME STAMP from “2014/07/12 00:00:00” to “2014/07/12 00:00:29” have been acquired.

In order to manage the logs acquired from the storage unit 20, the monitoring device 1 needs to identify each log. Therefore, for example, the LOG CONTENTS depicted in FIG. 9 need to be information that uniquely identifies each log.

More specifically, when the contents of the logs output by the physical machines 11 are themselves unique, the LOG CONTENTS of each log may set the contents of the log itself. Meanwhile, when the contents of the logs output by the physical machines 11 are themselves not unique, the LOG CONTENTS of each log may be set a contents including the contents of the log itself, the machine ID of the physical machine 11 that has output the log, and time (time stamp) at which the log has been output from the physical machine 11.

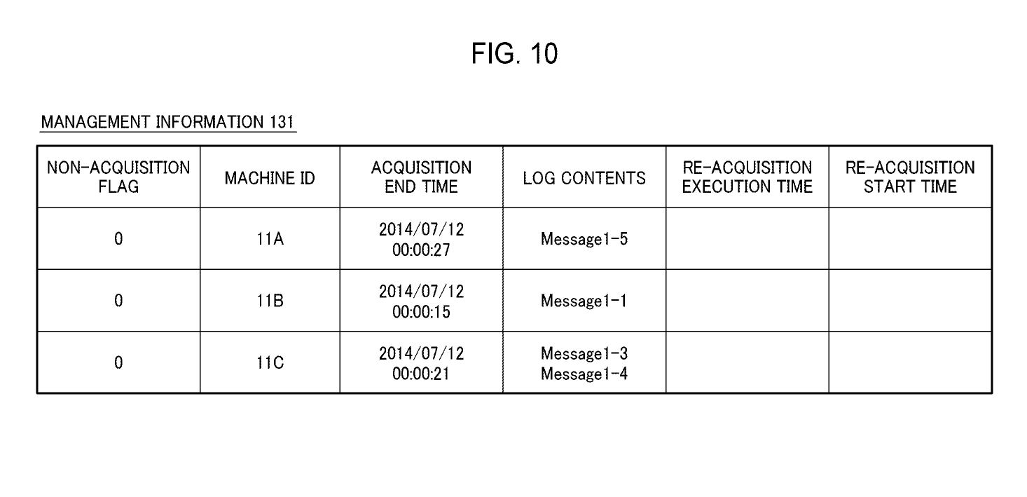

FIG. 10 illustrates a specific example of the management information 131 when it reflects the information relating to the logs depicted in FIG. 9.

The management information 131 depicted in FIG. 10 has a NON-ACQUISITION FLAG indicating whether or not a log was able to be acquired when the previous log acquisition processing has been executed, and the MACHINE ID described with reference to FIG. 2. The management information 131 depicted in FIG. 10 also has an ACQUISITION END TIME which is the most recent TIME STAMP for each physical machine 11, among the TIME STAMPS of the logs acquired by the monitoring device 1, and the LOG CONTENTS described with reference to FIG. 2. Furthermore, the management information 131 depicted in FIG. 10 also has a RE-ACQUISITION EXECUTION TIME indicating the time at which the execution of the past log acquisition has been completed and a RE-ACQUISITION START TIME indicating the earliest time in a range in which the past log acquisition needs to be performed.

More specifically, among the logs depicted in FIG. 9, the log with the TIME STAMP of “2014/07/12 00:00:19” and the log with the TIME STAMP of “2014/07/12 00:00:27” are present in the LOGs with the MACHINE ID of “11A”. Thus, among the logs with the MACHINE ID of “11A”, the log with the most recent TIME STAMP is the log with the TIME STAMP of “2014/07/12 00:00:27”. Therefore, the monitoring device 1 sets “2014/07/12 00:00:27” as the ACQUISITION END TIME corresponding to the information in which the MACHINE ID is “11A” and sets “Message 1-5” in the LOG CONTENTS in the management information 131 depicted in FIG. 10.

Further, among the logs depicted in FIG. 9, only the log with the TIME STAMP of “2014/07/12 00:00:15” is present in the LOG with the MACHINE ID of “11B”. Therefore, the monitoring device 1 sets “2014/07/12 00:00:15” as the ACQUISITION END TIME corresponding to the information in which the MACHINE ID is “11B” and sets “Message 1-1” in the LOG CONTENTS in the management information 131 depicted in FIG. 10.

Further, among the logs depicted in FIG. 9, two logs with the TIME STAMP of “2014/07/12 00:00:21” are present in the LOGs with the MACHINE ID of “11C”. Therefore, the monitoring device 1 sets “2014/07/12 00:00:21” as the ACQUISITION END TIME corresponding to the information in which the MACHINE ID is “11C” and sets two types of information, namely, “Message 1-3” and “Message 1-4”, in the LOG CONTENTS in the management information 131 depicted in FIG. 10.

Thus, the management information 131 depicted in FIG. 10 indicates that the acquisition of logs up to the time which has been set as the ACQUISITION END TIME has been completed for each physical machine.

Returning to FIG. 6, the log acquisition unit 111 acquires the log having the TIME STAMP corresponding to the time after the oldest time, among the times indicated by the most recent TIME STAMPS specified in S22 (S23).

More specifically, in the example of the management information 131 depicted in FIG. 10, “2014/07/12 00:00:27”, “2014/07/12 00:00:15”, and “2014/07/12 00:00:21” have been set in the ACQUISITION END TIME. Therefore, among those ACQUISITION END TIMES, the log acquisition unit 111 specifies “2014/07/12 00:00:15” which is the oldest ACQUISITION END TIME, and acquires from the storage unit 20 the logs having the TIME STAMP indicating the time after this oldest time. Thus, the time indicated by the oldest ACQUISITION END TIME, among the ACQUISITION END TIMES of the management information 131, is the time at which the monitoring device 1 completes the acquisition of logs with respect to all of the physical machines 11. Therefore, the log acquisition unit 111 does not need to perform log acquisition while changing the conditions for each physical machine 11 by acquiring the logs having the TIME STAMP indicating the time after the time indicated by the oldest ACQUISITION END TIME, among the ACQUISITION END TIMES of the management information 131.

When the log acquired from the storage unit 20 by the log acquisition processing is the log which has already been acquired (the log that has been stored as the acquired log 132 in the information storage region 130), the log acquisition unit 111 determines that this log is a duplicate log and destroys this log, without storing the log in the information storage region 130.

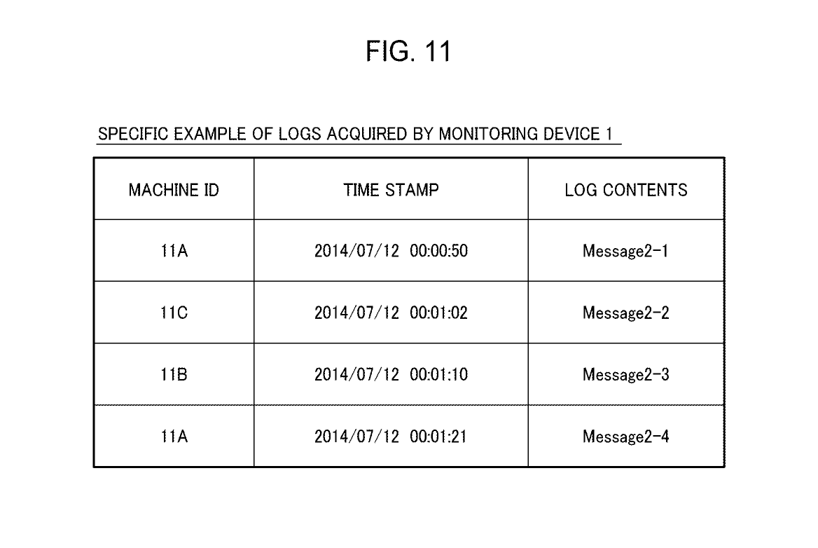

Further, FIG. 11 is a specific example of logs acquired by the monitoring device 1 in S23. In the example depicted in FIG. 11, the log acquisition unit 111 acquires, for example, a log with the MACHINE ID of “11A”, the TIME STAMP of “2014/07/12 00:00:50”, and the LOG CONTENTS of “Message 2-1”. The explanation of other logs depicted in FIG. 11 is herein omitted. The logs depicted in FIG. 11 represent the acquisition results relating to the case in which the logs with the TIME STAMPS, for example, from “2014/07/12 00:00:30” to “2014/07/12 00:01:29” have been acquired.

Returning to FIG. 6, by using the results of log acquisition from the storage unit 20 in S23, the log management unit 112 determines whether or not the log of the physical machine 11 for which information is not present in the management information 131 is present (S24).

More specifically, the logs depicted in FIG. 11 do not include a log output from a physical machine other than the physical machines 11A, 11B, and 11C for which the logs have been heretofore continuously acquired by the monitoring device 1. Therefore, the log management unit 112 determines that a log output from the physical machine 11 for which information is not present in the management information 131 is not present (NO in S24). A specific example of the case in which a log output from the physical machine 11 for which information is not present in the management information 131 is present will be described hereinbelow.

Then, by using the results of log acquisition from the storage unit 20 in S23, the log management unit 112 determines whether or not a physical machine for which a log was not able to be acquired is present among the physical machines for which the NON-ACQUISITION FLAG in the management information 131 is “0” (S27).

More specifically, in the management information 131 depicted in FIG. 10, “0” is set in the NON-ACQUISITION FLAG corresponding to the information in which the MACHINE ID is “11A”, “11B”, and “11C”. Further, the logs depicted in FIG. 11 include all of the logs for which the MACHINE ID is “11A”, “11B”, and “11C”. Therefore, the log management unit 112 determines that a physical machine for which a log was not able to be acquired is not present among the physical machines for which the non-acquisition flag in the management information 131 is “0” (NO in S27). A specific example of the case in which a physical machine from which a log was not able to be acquired is present among the physical machines for which the non-acquisition flag in the management information 131 is “0” will be described hereinbelow.

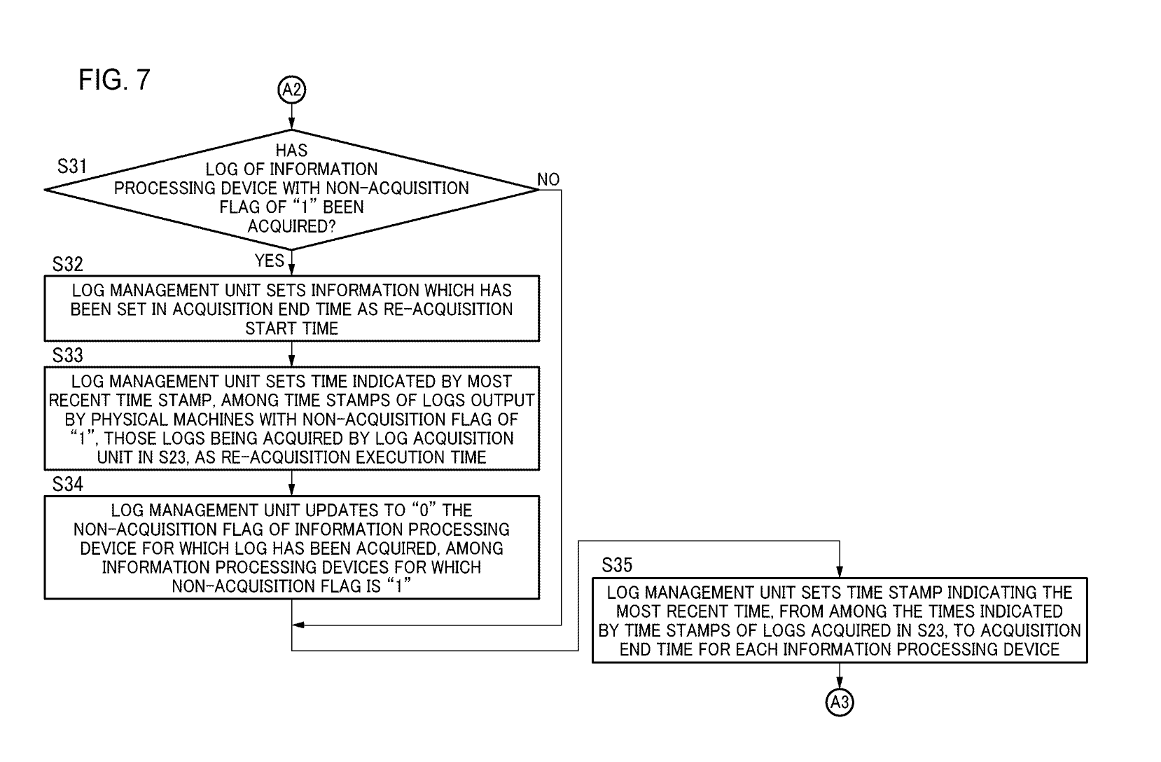

Then, by using the results of log acquisition from the storage unit 20 in S23, the log management unit 112 determines, as depicted in FIG. 7, whether or not the log of a physical machine for which the NON-ACQUISITION FLAG in the management information 131 is “1” has been acquired (S31).

More specifically, in the management information 131 depicted in FIG. 10, the NON-ACQUISITION FLAGS corresponding to all of the MACHINE IDs are “0”. Therefore, the log management unit 112 determines that the log of the physical machine for which the non-acquisition flag of the management information 131 is “1” has not been acquired (NO in S31). A specific example of the case in which the log of the machine for which the non-acquisition flag of the management information 131 is “1” has been acquired will be described hereinbelow.

Then, the log management unit 112 sets the TIME STAMP indicating the most recent time, among the times indicated by the TIME STAMPS of the logs acquired in S23, in the ACQUISITION END TIME for each physical machine (S35).

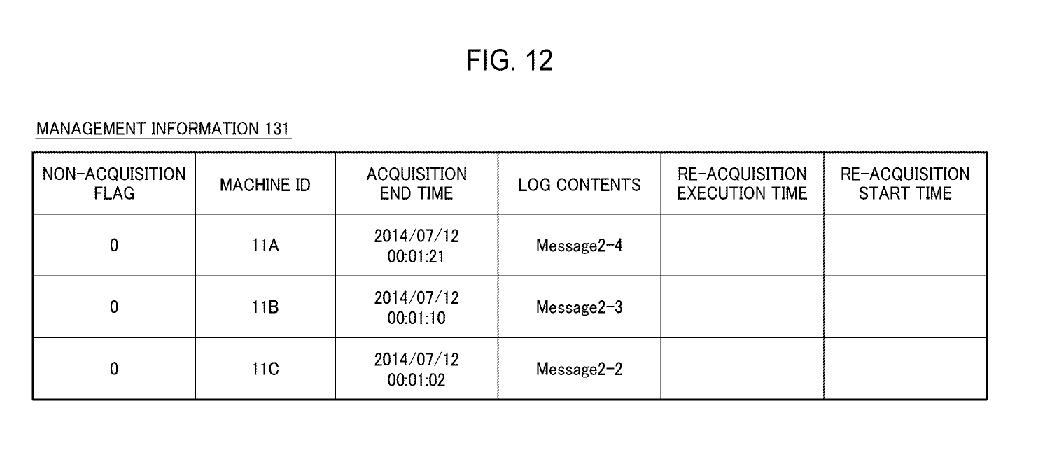

More specifically, there are two TIME STAMPS of the logs for which the MACHINE ID is “11A”, among the logs depicted in FIG. 11, namely, “2014/07/12 00:00:50” and “2014/07/12 00:01:21”. Therefore, the log management unit 112 sets “2014/07/12 00:01:21” in the TIME STAMP corresponding to the information in which the MACHINE ID is “11A”, and sets “Message 2-4 in the LOG CONTENTS, as depicted in FIG. 12. Likewise, the log management unit 112 sets “2014/07/12 00:01:10” in the TIME STAMP of the information in which the MACHINE ID is “11B”, and sets “Message 2-3” in the LOG CONTENTS. The log management unit 112 also sets “2014/07/12 00:01:02” in the TIME STAMP of the information in which the MACHINE ID is “11C”, and sets “Message 2-2” in the LOG CONTENTS.

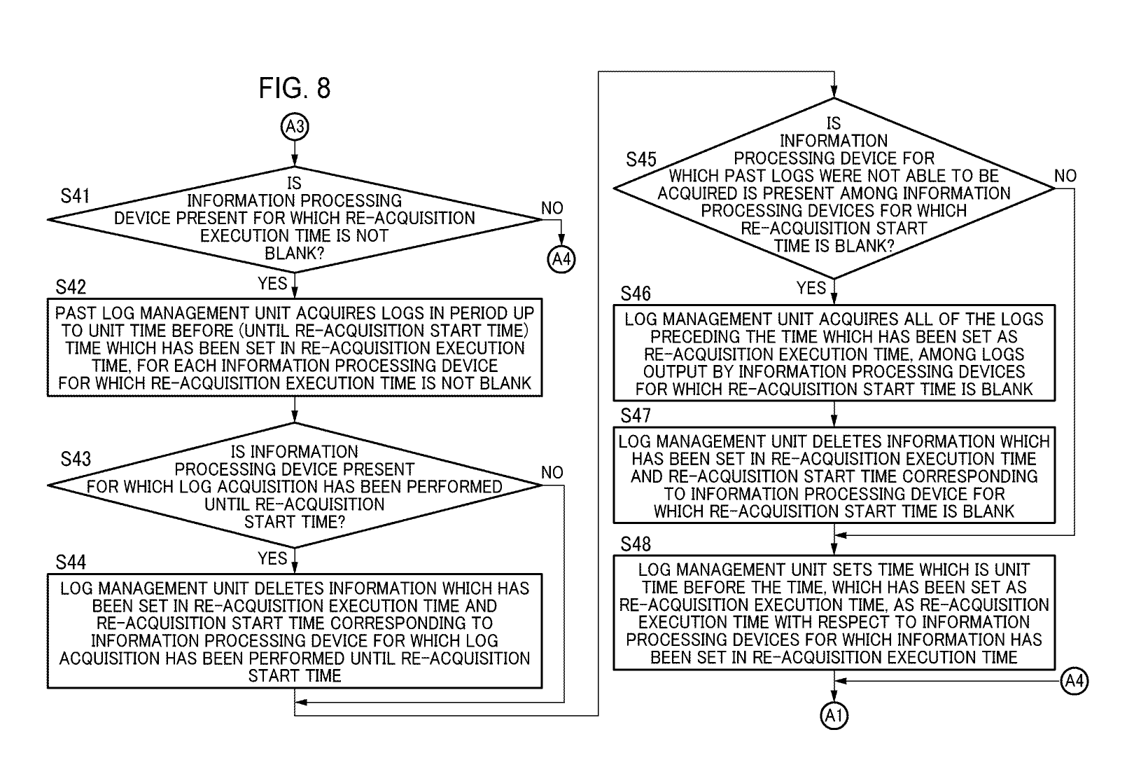

Then, the log management unit 112 determines, as depicted in FIG. 8, whether or not a physical machine is present for which the RE-ACQUISITION EXECUTION TIME of the management information 131 is not blank (S41).

More specifically, the RE-ACQUISITION EXECUTION TIME corresponding to all of the MACHINE IDs in the management information 131 depicted in FIG. 12 is blank. Therefore, the log management unit 112 determines that there is no physical machine for which the re-acquisition execution time of the management information 131 is not blank (NO in S41). A specific example of the case in which a physical machine for which the re-acquisition execution time in the management information 131 is not blank is present will be described hereinbelow.

The log acquisition unit 111 then waits again until the log acquisition timing (S21).

Thus, when the logs were able to be acquired from all of the physical machines for which the logs have been continuously acquired, the log management unit 112 performs only the update of information set in the ACQUISITION END TIME and LOG CONTENTS without updating the information set in the NON-ACQUISITION FLAG, RE-ACQUISITION EXECUTION TIME, and RE-ACQUISITION START TIME.

[Specific Example of the Case in which Physical Machine for which Log was not Able to be Acquired is Present]

A specific example of the case in which a physical machine for which the log was not able to be acquired is present among the physical machines for which the NON-ACQUISITION FLAG in the management information 131 is “0” will be described hereinbelow.

Initially, the log acquisition unit 111, for example, waits until the execution timing of the log acquisition processing in the same manner as described hereinabove (NO in S21). Then, when the execution timing of the log acquisition processing is reached (YES in S21), the log acquisition unit 111, for example, refers to the management information 131 in the same manner as described hereinabove. Explained hereinbelow is the case in which the log acquisition unit 111 refers to the management information 131 depicted in FIG. 12.

The log acquisition unit 111, for example, specifies the most recent TIME STAMP among the TIME STAMPS of the logs, which have been output in the past by the physical machines 11, for each physical machine 11 for which the NON-ACQUISITION FLAG included in the management information 131 is “0” (S22). More specifically, in the management information 131 depicted in FIG. 12, the log acquisition unit 111 specifies “2014/07/12 00:01:21”, “2014/07/12 00:01:10”, and “2014/07/12 00:01:02”.

Then, the log acquisition unit 111 acquires, for example, the logs having the TIME STAMP corresponding to the time after the oldest time, among the times indicated by the most recent TIME STAMP specified in S22 (S23). Thus, in the management information 131 depicted in FIG. 12, the log acquisition unit 111 acquires the log having the TIME STAMP corresponding to the time after “2014/07/12 00:01:02”.

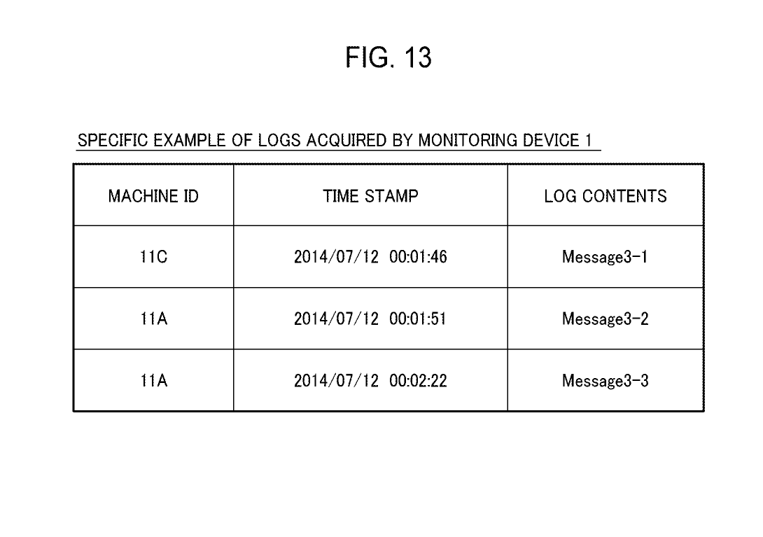

As a result, the log acquisition unit 111 acquires, for example, the log for which the MACHINE ID is “11C”, the TIME STAMP is “2014/07/12 00:01:46”, and the LOG CONTENTS are “Message 3-1”, as depicted in FIG. 13. The explanation of other logs in FIG. 13 is omitted. The logs depicted in FIG. 13 are the log relating to the case in which the logs have been acquired, for example, within the range of TIME STAMPS from “2014/07/12 00:01:30” to “2014/07/12 00:02:29”.

Then, by using the results of log acquisition from the storage unit 20 in S23, the log management unit 112 determines that a log output from the physical machine 11 for which information is not present in the management information 131 is not present (NO in S24).

Then, by using the results of log acquisition from the storage unit 20 in S23, the log management unit 112 determines whether or not a physical machine for which a log was able to be acquired is present among the physical machines for which the non-acquisition flag of the management information 131 is “0” (S27). In this case, in the logs depicted in FIG. 13, a log for which the MACHINE ID is “11B” is not present. Therefore, the log management unit 112 determines that a physical machine for which the log was not able to be acquired is present among the physical machines for which the non-acquisition flag of the management information 131 is “0” (YES in S27).

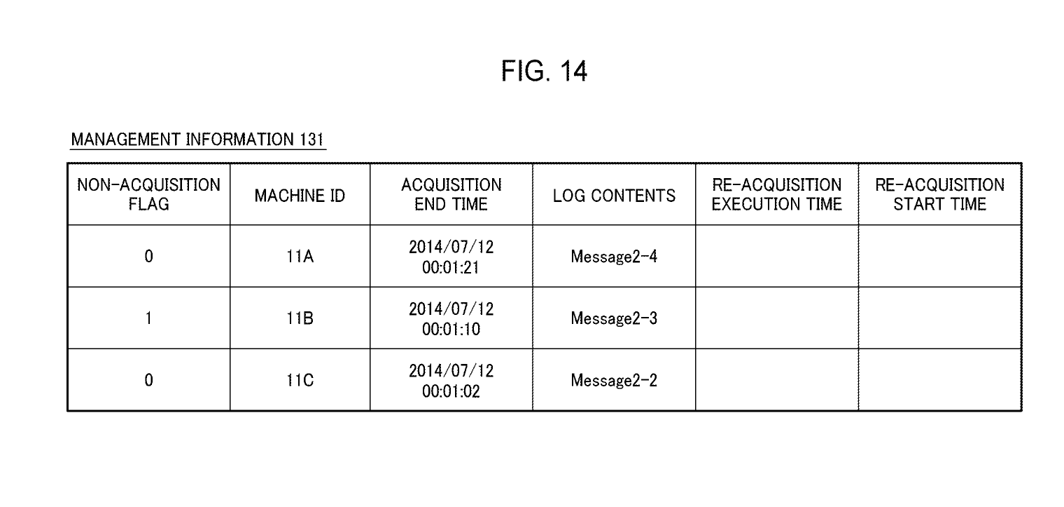

For example, the log management unit 112 then updates to “1” the non-acquisition flag corresponding to the physical machine for which the log was not able to be acquired (S28). More specifically, the log management unit 112 updates the NON-ACQUISITION FLAG for which the MACHINE ID is “11B” to “1”, as depicted in FIG. 14. As a result, the log management unit 112 can store, in the management information 131, the information specifying the physical machine for which the log was not able to be acquired by the log acquisition processing.

Then, for example, by using the results of log acquisition from the storage unit 20 in S23, the log management unit 112 determines that the log of the physical machine for which the non-acquisition flag of the management information 131 is “1” has not been acquired (NO in S31).

Then, the log management unit 112 sets the TIME STAMP indicating the most recent time, among the times indicated by the TIME STAMPS of the logs acquired in S23, in the ACQUISITION END TIME for each physical machine (S35).

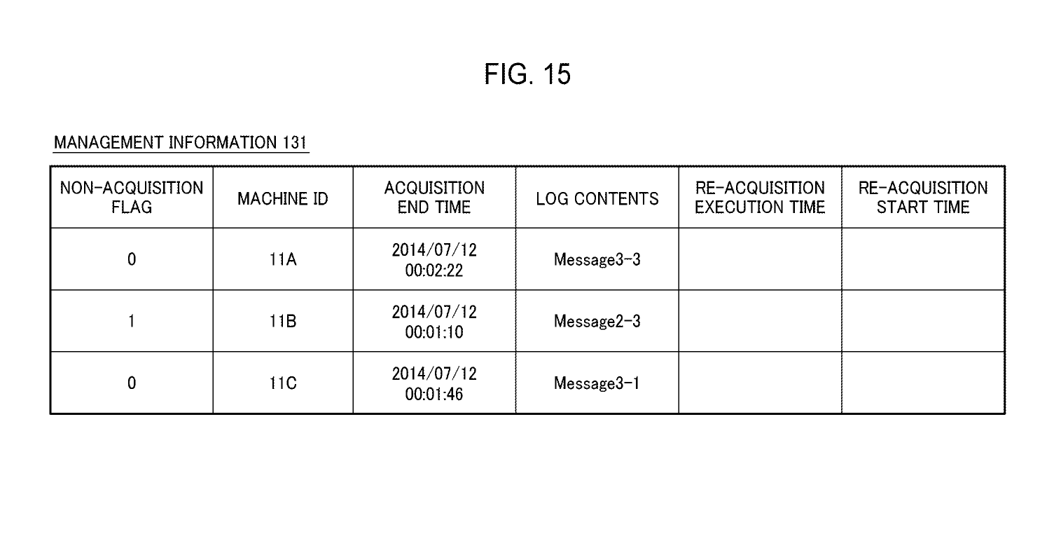

More specifically, by referring to the logs depicted in FIG. 13, the log management unit 112 updates, as depicted in FIG. 15, the management information 131 depicted in FIG. 14. Thus, the log management unit 112 sets “2014/07/12 00:02:22” in the ACQUISITION END TIME corresponding to the information in which the MACHINE ID is “11A”, and sets “Message 3-3” in the LOG CONTENTS. The log management unit 112 then, sets “2014/07/12 00:01:46” in the ACQUISITION END TIME corresponding to the information in which the MACHINE ID is “11C”, and sets “Message 3-1” in the LOG CONTENTS.

In this case, since the logs depicted in FIG. 13 do not include a log for which the MACHINE ID is “11B”, the log management unit 112 does not update the information in which the MACHINE ID is “11B” in the management information 131. Thus, in the ACQUISITION END TIME of the management information 131 depicted in FIG. 15, the time “2014/07/12 00:01:10” at which the acquisition of logs has been completed in the monitoring device 1, among the logs output by the physical machine 11B for which the log was not able to be acquired, is maintained. As a result, the monitoring device 1 can perform the acquisition of past logs, as will be described hereinbelow.

Then, the log management unit 112, for example, refers to the management information 131 depicted in FIG. 15 and determines that a physical machine for which the re-acquisition execution time is not blank is not present (NO in S41). The log acquisition unit 111 then waits again until the log acquisition timing (S21).

[Specific Example of the Case in which Log is not Able to be Acquired from Physical Machine for which Non-Acquisition Flag is “1”]

A specific example of the case in which a physical machine for which a log was not able to be acquired is present among the physical machines for which the NON-ACQUISITION FLAG in the management information 131 is “1” will be described hereinbelow.

Initially, the log acquisition unit 111, for example, waits until the execution timing of log acquisition processing in the same manner as described hereinabove (NO in S21). Then, after the execution timing of the first log acquisition processing has been reached (YES in S21), the log acquisition unit 111, for example, refers to the management information 131 in the same manner as described hereinabove. In the case explained herein, the log acquisition unit 111 refers to the management information 131 depicted in FIG. 15.

Then, the log acquisition unit 111 specifies, for example, the most recent TIME STAMP, among the TIME STAMPS of the logs output by each physical machine 11 in the past, for each physical machine 11 for which the non-acquisition flag included in the management information 131 is “0” (S22). More specifically, in the management information 131 depicted in FIG. 15, the log acquisition unit 111 specifies “2014/07/12 00:02:22” and “2014/07/12 00:01:46” which are the ACQUISITION END TIMES corresponding to the information in which the NON-ACQUISITION FLAG is “0”.

Then, the log acquisition unit 111, for example, acquires a log having the TIME STAMP corresponding to a time after the oldest time, among the times indicated by the most recent TIME STAMPS specified in S22 (S23). More specifically, in the management information 131 depicted in FIG. 15, the log acquisition unit 111 acquires the log having the TIME STAMP corresponding to the time after “2014/07/12 00:01:46”.

Thus, where a physical machine with the NON-ACQUISITION FLAG of “1” is present, the time difference between the time specified in the ACQUISITION END INFORMATION corresponding to the information in which the NON-ACQUISITION FLAG is “1” and the time specified in the ACQUISITION END INFORMATION corresponding to the information in which the NON-ACQUISITION FLAG is “0” increases. More specifically, in the example indicating the management information in FIG. 15, the difference becomes larger than the execution interval (for example, 1 min) of the log acquisition processing. Therefore, where the log acquisition unit 111 acquires logs having TIME STAMPS indicating the time after the time set in the ACQUISITION END INFORMATION corresponding to the information in which the NON-ACQUISITION FLAG is “1”, a large number of logs (duplicate logs) that have already been acquired by the monitoring device 1 are included in the acquired logs.

Accordingly in S22 the log acquisition unit 111 specifies the TIME STAMPS without considering the ACQUISITION END INFORMATION corresponding to the information in which the non-acquisition flag is “1”. Further, in S23, the log acquisition unit 111 performs log acquisition on the basis of the specified TIME STAMPS, without considering the ACQUISITION END INFORMATION corresponding to the information in which the non-acquisition flag is “1”. As a result, the log acquisition unit 111 can reduce the number of duplicate logs that will be acquired and can prevent the increase in the processing load of the monitoring device 1.

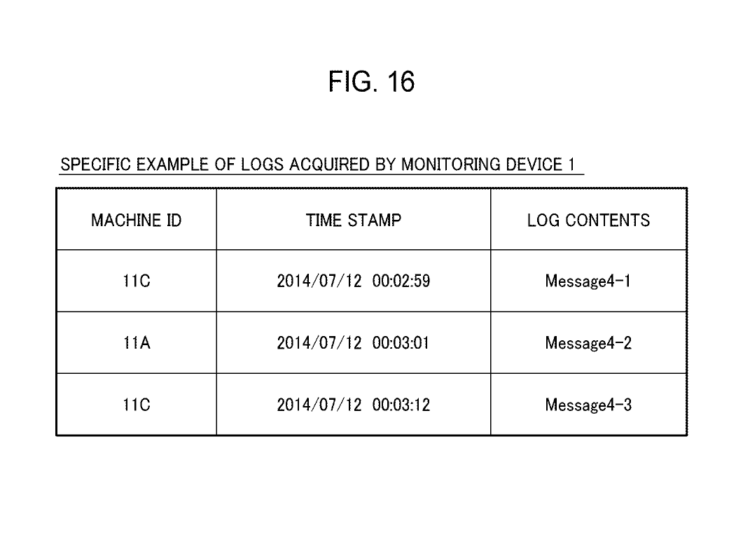

More specifically, the log acquisition unit 111, for example, acquires a log with the MACHINE ID of “11C”, the TIME STAMP of “2014/07/12 00:02:59”, and the LOG CONTENTS of “Message 4-1”, as depicted in FIG. 16. The explanation relating to other logs depicted in FIG. 16 is herein omitted. The logs depicted in FIG. 16 are, for example, the acquisition results relating to the case in which the logs with the TIME STAMPS between “2014/07/12 00:02:30” and “2014/07/12 00:03:29” have been acquired.

Then, for example, by using the results of log acquisition from the storage unit 20 in S23, the log management unit 112 determines that a log output from the physical machines 11 for which information is not present in the management information 131 is not present (NO in S24).

Further, for example, by using the results of log acquisition from the storage unit 20 in S23, the log management unit 112 determines whether or not a physical machine for which the log was not able to be acquired is present among the physical machines for which the non-acquisition flag in the management information 131 is “0” (S27). More specifically, in the management information 131 depicted in FIG. 15, the information in which the NON-ACQUISITION FLAG is “0” is the MACHINE ID of “11A” and “11C”. Further, logs for which the MACHINE ID is “11A” and “11C” are included in the logs depicted in FIG. 16. Therefore, the log management unit 112 determines that a physical machine for which the log was not able to be acquired is not present among the physical machines for which the non-acquisition flag in the management information 131 is “0” (NO in S27).

Further, for example, by using the results of log acquisition from the storage unit 20 in S23, the log management unit 112 determines that the log of the physical machine for which the non-acquisition flag in the management information 131 is “1” has not been acquired (NO in S31).

Further, the log management unit 112 sets the time stamp indicating the most recent time, among the times indicated by the time stamps of the logs acquired in S23, to the acquisition end time for each physical machine (S35).

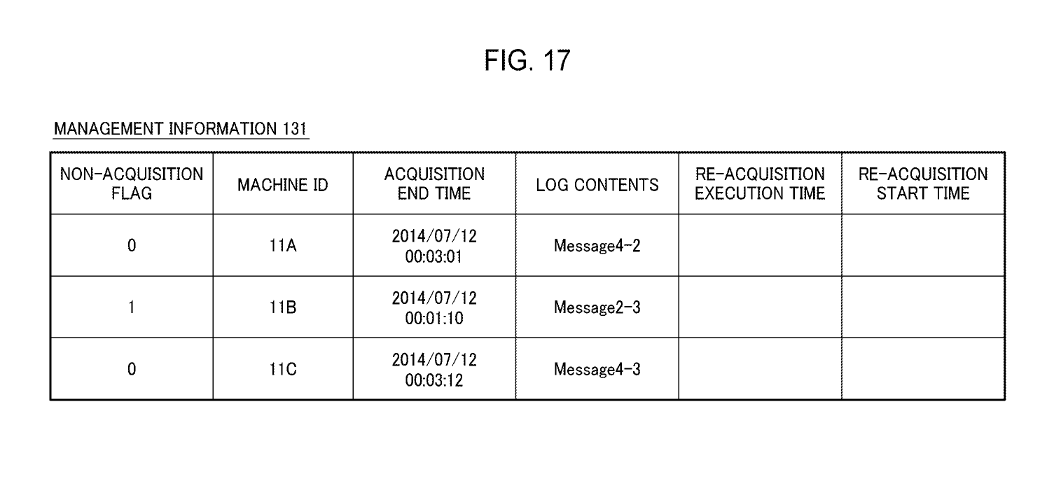

More specifically, the log management unit 112 refers to the logs depicted in FIG. 16 and updates, as depicted in FIG. 17, the management information depicted in FIG. 15. Thus, the log management unit 112 sets “2014/07/12 00:03:01” in the ACQUISITION END TIME corresponding to the information in which the MACHINE ID is “11A”, and sets “Message 4-2” in the LOG CONTENTS. The log management unit 112 also sets “2014/07/12 00:03:12” in the ACQUISITION END TIME corresponding to the information in which the MACHINE ID is “11C”, and sets “Message 4-3” in the LOG CONTENTS.

In this case, since the logs depicted in FIG. 16 do not include a log for which the MACHINE ID is “11B”, the log management unit 112 does not update the information in which the MACHINE ID is “11B” in the management information 131. Thus, in the ACQUISITION END TIME of the management information 131 depicted in FIG. 15, the time at which the acquisition of logs by the monitoring device 1 has been completed is continuously maintained without updating.

Then, the log management unit 112, for example, refers to the management information 131 depicted in FIG. 15 and determines that a physical machine for which the re-acquisition execution time is not blank is not present (NO in S41). The log acquisition unit 111 then waits again until the log acquisition timing (S21).

[Specific Example of the Case in which Log was Able to be Acquired from Physical Machine for which Non-Acquisition Flag is “1”]

A specific example of the case in which a physical machine for which a log was able to be acquired is present among the physical machines for which the non-acquisition flag of the management information 131 is “1” will be described hereinbelow.

Initially, the log acquisition unit 111, for example, waits until the execution timing of log acquisition processing in the same manner as described hereinabove (NO in S21). Then, after the execution timing of the first log acquisition processing has been reached (YES in S21), the log acquisition unit 111, for example, refers to the management information 131 in the same manner as described hereinabove. In the case explained herein, the log acquisition unit 111 refers to the management information 131 depicted in FIG. 17.

Then, the log acquisition unit 111 specifies, for example, the most recent TIME STAMP, among the TIME STAMPS of the logs output by each physical machine 11 in the past, for each physical machine 11 for which the non-acquisition flag included in the management information 131 is “0” (S22). More specifically, in the management information 131 depicted in FIG. 17, the log acquisition unit 111 specifies “2014/07/12 00:03:01” and “2014/07/12 00:03:12” which are the ACQUISITION END TIMES corresponding to the information in which the NON-ACQUISITION FLAG is “0”.

Then, the log acquisition unit 111, for example, acquires a log having the TIME STAMP corresponding to a time after the oldest time, among the times indicated by the most recent TIME STAMPS specified in S22 (S23). More specifically, in the management information 131 depicted in FIG. 17, the log acquisition unit 111 acquires the log having the TIME STAMP corresponding to the time after “2014/07/12 00:03:01”.

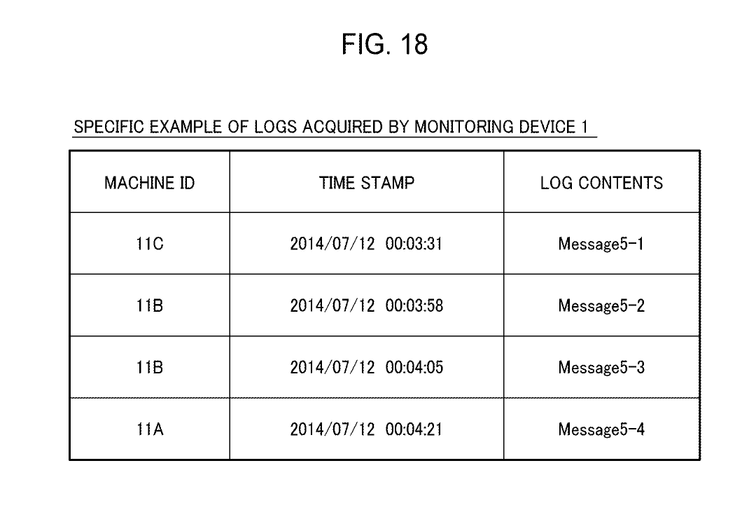

More specifically, the log acquisition unit 111, for example, acquires a log with the MACHINE ID of “11C”, the TIME STAMP of “2014/07/12 00:03:31”, and the LOG CONTENTS of “Message 5-1”, as depicted in FIG. 18. The explanation relating to other logs depicted in FIG. 18 is herein omitted. The logs depicted in FIG. 18 are, for example, the acquisition results relating to the case in which the logs with the TIME STAMPS between “2014/07/12 00:03:30” and “2014/07/12 00:04:29” have been acquired.

Then, for example, by using the results of log acquisition from the storage unit 20 in S23, the log management unit 112 determines that a log output from the physical machines 11 for which information is not present in the management information 131 is not present (NO in S24).

Further, for example, by using the results of log acquisition from the storage unit 20 in S23, the log management unit 112 determines whether or not a physical machine for which the log was not able to be acquired is present among the physical machines for which the non-acquisition flag in the management information 131 is “0” (S27). More specifically, in the management information 131 depicted in FIG. 17, the information in which the NON-ACQUISITION FLAG is “0” is the MACHINE ID of “11A” and “11C”. Further, logs for which the MACHINE ID is “11A” and “11C” are included in the logs depicted in FIG. 18. Therefore, the log management unit 112 determines that a physical machine for which the log was not able to be acquired is not present among the physical machines for which the non-acquisition flag in the management information 131 is “0” (NO in S27).

Further, for example, by using the results of log acquisition from the storage unit 20 in S23, the log management unit 112 determines whether or not the log of a physical machine for which the NON-ACQUISITION FLAG in the management information 131 is “1” has been acquired (S31). More specifically, in the management information 131 depicted in FIG. 17, the MACHINE ID corresponding to the information in which the NON-ACQUISITION FLAG is “1” is “11B”. Further, the log with the MACHINE ID of “11B” is present among the logs depicted in FIG. 18. Therefore, the log management unit 112 determines that the log of the physical machine for which the non-acquisition flag of the management information 131 is “1” has been acquired (YES in S31).

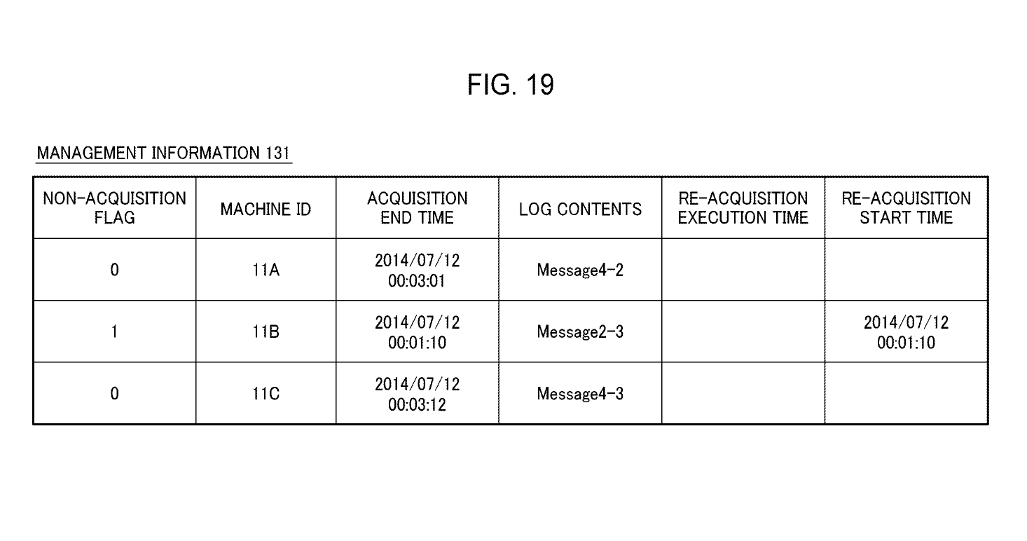

Then, the log management unit 112 sets the information, which has been set in the ACQUISITION END TIME in the management information 131, to RE-ACQUISITION START TIME (S32). More specifically, the log management unit 112, for example, sets “2014/07/12 00:01:10”, which is the information which has been set in the ACQUISITION END TIME, as the RE-ACQUISITION START TIME corresponding to the information in which the NON-ACQUISITION FLAG is “1”, as depicted in FIG. 19.

Thus, the information which has been set in the ACQUISITION END TIME corresponding to the information in which the NON-ACQUISITION FLAG is “1” is needed for specifying the logs which have already been acquired by the log acquisition unit 111 when the past log acquisition unit 113 acquires the past logs, as will be described hereinbelow. However, since the log output by the physical machine for which the NON-ACQUISITION FLAG is “1” has been acquired in S23, the log management unit 112 needs to set the TIME STAMP of the acquired log as the ACQUISITION END TIME corresponding to the information in which the NON-ACQUISITION FLAG is “1”. Accordingly, the log management unit 112 sets the time stamp, which has been set in the ACQUISITION END TIME, as the RE-ACQUISITION START TIME before the information which has been set in the ACQUISITION END TIME corresponding to the information in which the NON-ACQUISITION FLAG is “1” is updated. As a result, the log management unit 112 can maintain the information which has been set as the ACQUISITION END TIME corresponding to the information in which the NON-ACQUISITION FLAG is “1”.

Then, the log management unit 112 sets the time indicated by the most recent TIME STAMP, among the TIME STAMPS of the logs output by the physical machines for which the NON-ACQUISITION FLAG is “1”, those logs being acquired by the log acquisition unit 111 in S23, as the RE-ACQUISITION EXECUTION TIME in the management information 131 (S33). Thus, the log management unit 112 sets the TIME STAMP of the log which serves as a reference for past log acquisition when the past log acquisition unit 113 acquires the past logs, as will be described hereinbelow, as the RE-ACQUISITION EXECUTION TIME. As a result, the log management unit 112 can manage the interval of time from the time which has been set in the RE-ACQUISITION START TIME to the time which has been set in the RE-ACQUISITION EXECUTION TIME as the time in which the acquisition of past logs needs to be performed.

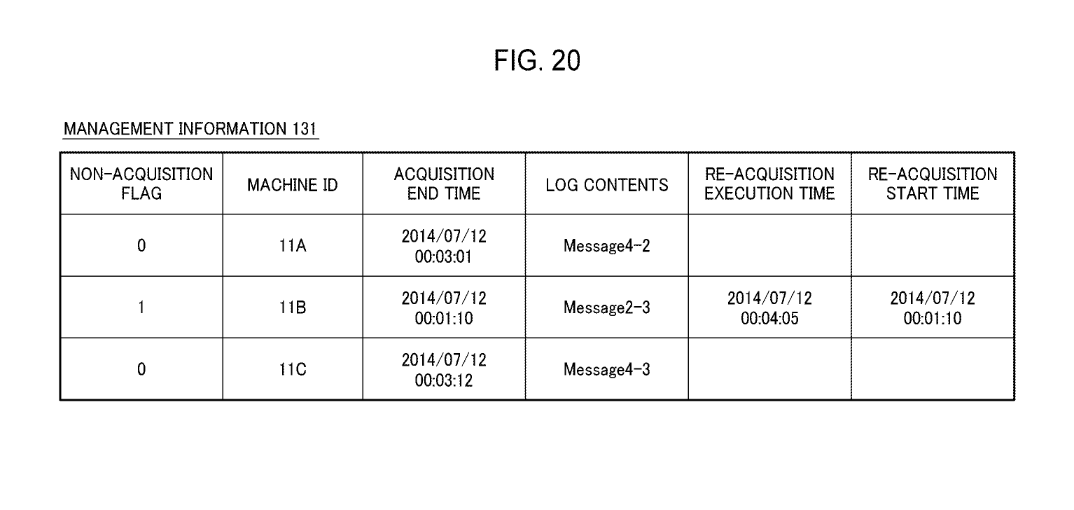

More specifically, as depicted in FIG. 20, the log management unit 112 sets “2014/07/12 00:04:05”, which is the most recent TIME STAMP, among the TIME STAMPS of the logs for which the MACHINE ID is “11B”, those logs being included in the logs depicted in FIG. 18, as the RE-ACQUISITION EXECUTION TIME.

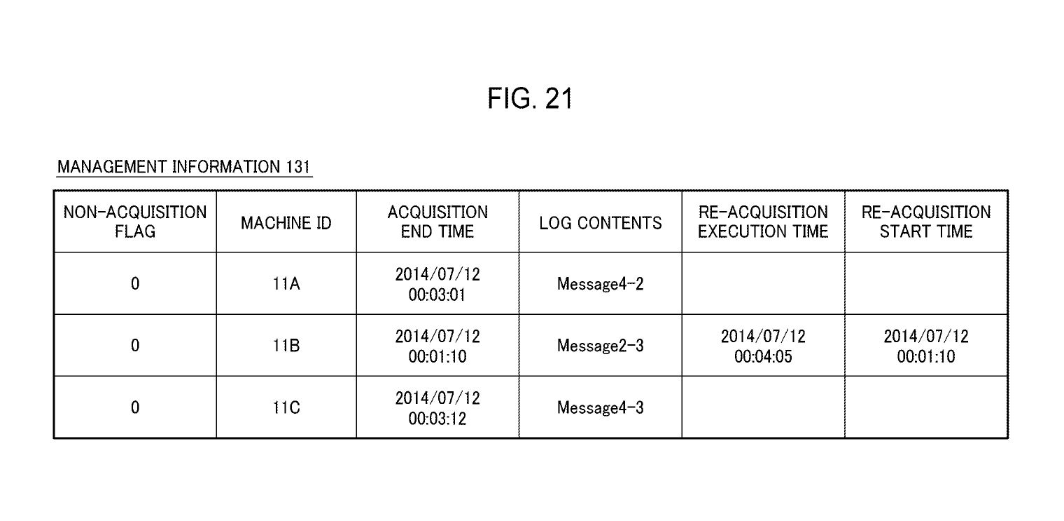

The log management unit 112 then updates to “0” the NON-ACQUISITION FLAG of the physical machine for which the log has been acquired, among the physical machines for which the non-acquisition flag is “1” (S34). More specifically, as depicted in FIG. 21, the log management unit 112 updates to “0” the NON-ACQUISITION FLAG corresponding to the information in which the RE-ACQUISITION EXECUTION TIME and RE-ACQUISITION START TIME have been set in S32 and S33.

Then, the log management unit 112 sets the time indicated by the most recent TIME STAMP, among the times indicated by the TIME STAMPS of the logs acquired in S23, as the ACQUISITION END TIME for each physical machine (S35).

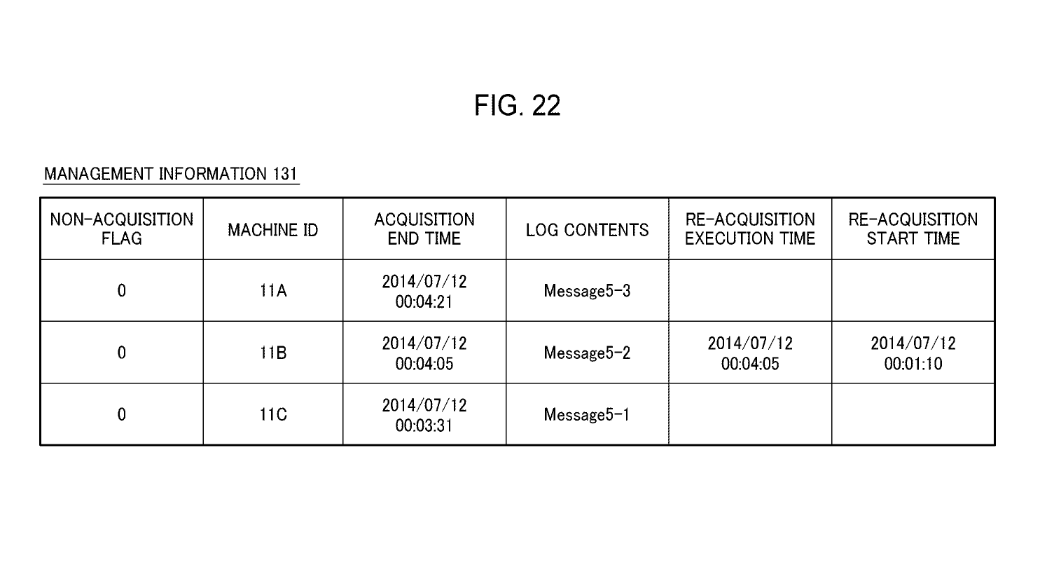

More specifically, by referring to the logs depicted in FIG. 18, the log management unit 112 updates, as depicted in FIG. 22, the management information 131 depicted in FIG. 21. Thus, the log management unit 112 sets “2014/07/12 00:04:21” as the ACQUISITION END TIME corresponding to the information in which the MACHINE ID is “11A”, and sets “Message 5-3” in the LOG CONTENTS. The log management unit 112 then sets “2014/07/12 00:04:05” as the ACQUISITION END TIME corresponding to the information in which the MACHINE ID is “11B”, and sets “Message 5-2” in the LOG CONTENTS. The log management unit 112 also sets “2014/07/12 00:03:31” as the ACQUISITION END TIME corresponding to the information in which the MACHINE ID is “11C”, and sets “Message 5-1” in the LOG CONTENTS.

Then, the log management unit 112, refers to the management information 131 depicted in FIG. 22 and determines whether or not a physical machine for which the RE-ACQUISITION EXECUTION TIME is not blank is present (S41).

More specifically, in the management information 131 depicted in FIG. 22, the information has been set in the RE-ACQUISITION EXECUTION TIME corresponding to the information in which the MACHINE ID is “11B”. Therefore, the log management unit 112 determines that a physical machine for which the RE-ACQUISITION EXECUTION TIME is not blank is present (YES in S41).

Then, the past log acquisition unit 113, for example, acquires logs in a period up to a unit time before the time which has been set in the RE-ACQUISITION EXECUTION TIME, for each physical machine for which the RE-ACQUISITION EXECUTION TIME is not blank (S42). The unit time may be, for example, the time (for example, 1 min) equal to the time interval in which the log acquisition unit 111 executes the log acquisition processing. Thus, the past log acquisition unit 113, acquires in a stepwise manner the logs within a period going back by a unit time, for example, each time the log acquisition unit 111 performs the acquisition of logs from the storage unit 20. As a result, when a large number of the past logs which are to be acquired are present, the past log acquisition unit 113 can prevent the occurrence of a processing delay which accompanies the increase in the processing load in the monitoring device 1. In the explanation hereinbelow, the unit time is 1 min.

More specifically, the past log acquisition unit 113 calculates a time of 0 h, 3 min, 5 sec on Jul. 12, 2014, which is 1 min before the time which has been set in the RE-ACQUISITION EXECUTION TIME in the management information 131 depicted in FIG. 22. Then, the past log acquisition unit 113 accesses the storage unit 20 and acquires logs output within 1 min from 0 h, 3 min, 5 sec on Jul. 12, 2014 to 0 h, 4 min, 5 sec on Jul. 12, 2014, among the logs that have been output by the physical machine 11B.

When the time which is 1 min before the time which has been set in the RE-ACQUISITION EXECUTION TIME is before the time (0 h, 1 min, 10 sec on Jul. 12, 2014 in the example depicted in FIG. 22) which has been set in the RE-ACQUISITION START TIME, the past log acquisition unit 113 performs log acquisition from the time which has been set in the RE-ACQUISITION START TIME to the time which has been set in the RE-ACQUISITION EXECUTION TIME. As a result, the past log acquisition unit 113 can prevent the acquisition of logs having the TIME STAMP indicating the time before the time which has been set in the RE-ACQUISITION START TIME. A specific example of the case in which the past log acquisition unit 113 performs log acquisition from the time which has been set in the RE-ACQUISITION START TIME to the time which has been set in the RE-ACQUISITION EXECUTION TIME will be explained hereinbelow.

Then, the past log acquisition unit 113, for example, determines whether or not a physical machine for which log acquisition has been performed going back until the RE-ACQUISITION START TIME in the management information 131 is present (S43). More specifically, in the example of the management information 131 depicted in FIG. 22, the past log acquisition unit 113 performs the acquisition of logs which have been output within 1 min from 0 h, 3 min, 5 sec on Jul. 12, 2014 to 0 h, 4 min, 5 sec on Jul. 12, 2014, among the logs output by the physical machine 11B. Therefore, the past log acquisition unit 113 determines that a physical machine for which log acquisition has been performed going back until the RE-ACQUISITION START TIME in the management information 131 is not present (NO in S43). A specific example of the case in which a physical machine for which log acquisition has been performed going back until the RE-ACQUISITION START TIME in the management information 131 is present will be described hereinbelow.

Then, the past log acquisition unit 113, for example, determines whether or not a physical machine for which past logs were not able to be acquired is present among the physical machines for which the RE-ACQUISITION START TIME in the management information 131 is blank (S45). More specifically, in the example for the management information 131 depicted in FIG. 22, a physical machine for which the RE-ACQUISITION START TIME is blank and for which the past log acquisition unit 113 was not able to acquire the past logs is not present. Therefore, the past log acquisition unit 113 determines that a physical machine for which the past logs were not able to be acquired is not present among the physical machines for which the RE-ACQUISITION START TIME in the management information 131 is blank (NO in S45). A specific example of the case in which it is determined that a physical machine for which the past logs were not able to be acquired is present among the physical machines for which the RE-ACQUISITION START TIME in the management information 131 is blank will be described hereinbelow.

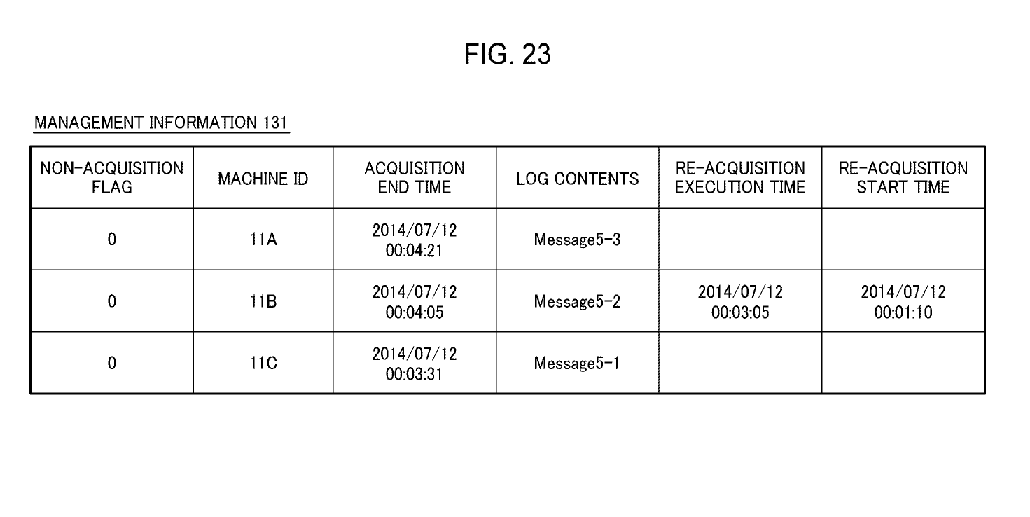

Then, the log management unit 112 resets, as the RE-ACQUISITION EXECUTION TIME, the time which is by a unit time before the time which has been set in the RE-ACQUISITION EXECUTION TIME, with respect to the physical machines for which information has been set in the RE-ACQUISITION EXECUTION TIME of the management information 131 (S48). More specifically, the log management unit 112 resets “2014/07/12 00:03:05”, which is 1 min before the time which has been set in the RE-ACQUISITION EXECUTION TIME, as the RE-ACQUISITION EXECUTION TIME, as depicted in FIG. 23. The log management unit 112 does not reset the RE-ACQUISITION EXECUTION TIME when information has not been set in the RE-ACQUISITION EXECUTION TIME.

Then, the log acquisition unit 111 waits again until the log acquisition timing (S21).

[Specific Example of Case in which Acquisition of Past Logs is Performed]

A specific example of the case in which the acquisition of past logs is performed will be explained hereinbelow with respect to the example of the management information 131 depicted in FIG. 23. The explanation of features which have already been explained hereinabove will be hereinbelow omitted as appropriate.

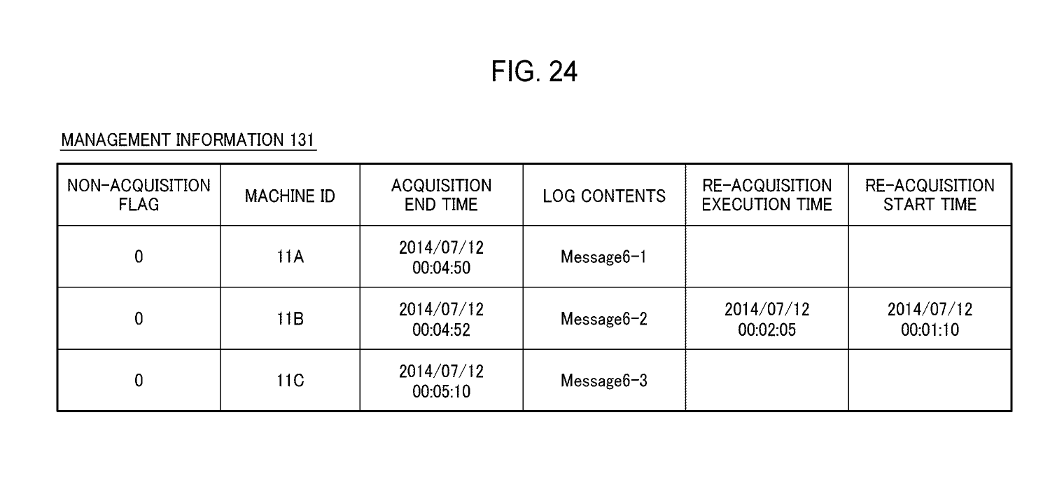

When the log acquisition unit 111 performs the next log acquisition processing in the example illustrated by the management information 131 depicted in FIG. 23 (S23), the log acquisition unit 111 updates the ACQUISITION END TIME and LOG CONTENTS, in the same manner as described hereinabove, as illustrated by the management information 131 depicted in FIG. 24 (S35).

More specifically, in the example depicted in FIG. 24, in the information in which the MACHINE ID is “11A”, “2014/07/12 00:04:50” is set in the ACQUISITION END TIME and “Message 6-1” is set in the LOG CONTENTS. Further, in the information in which the MACHINE ID is “11B”, “2014/07/12 00:04:52” is set in the ACQUISITION END TIME and “Message 6-2” is set in the LOG CONTENTS. In the information in which the MACHINE ID is “11C”, “2014/07/12 00:05:10” is set in the ACQUISITION END TIME and “Message 6-3” is set in the LOG CONTENTS.

Then, the past log acquisition unit 113 performs the acquisition of past logs on the basis of the information which has been set in the RE-ACQUISITION EXECUTION TIME in the management information 131 (S42). More specifically, the past log acquisition unit 113 calculates 0 h, 2 min, 5 sec on Jul. 12, 2014, which is 1 min before “2014/07/12 00:03:05” which is the information that has been set in the RE-ACQUISITION EXECUTION TIME in FIG. 23. Then, the past log acquisition unit 113 accesses the storage unit 20 and acquires the logs output over 1 min from 0 h, 2 min, 5 sec on Jul. 12, 2014 to 0 h, 3 min, 5 sec on Jul. 12, 2014, among the logs output by the physical machine 11B. The log management unit 112 also sets “2014/07/12 00:02:05” as the RE-ACQUISITION EXECUTION TIME (S48).

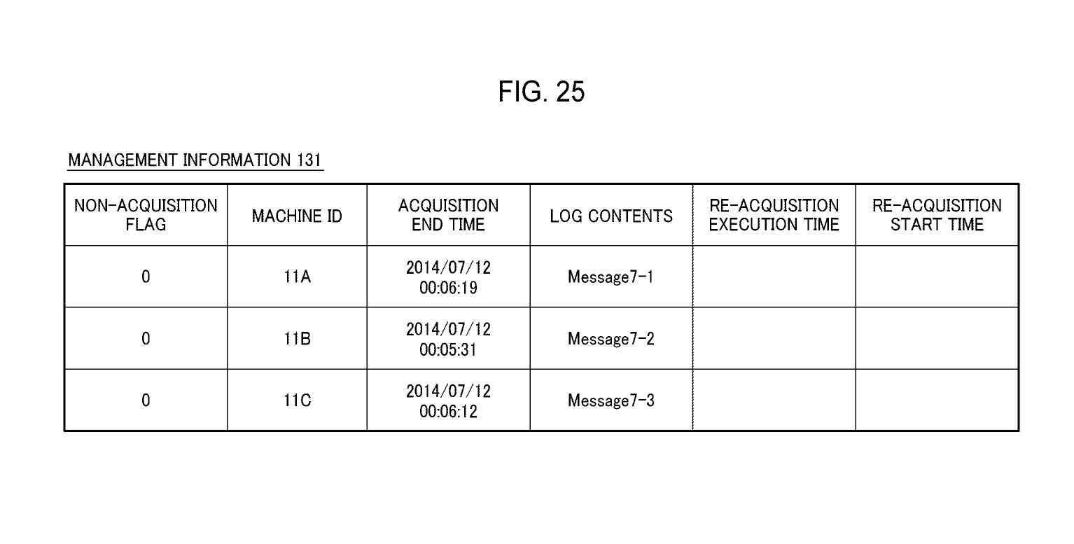

Then, when the log acquisition unit 111 executes the next log acquisition processing in the example represented by the management information 131 depicted in FIG. 24 (S23), the log acquisition unit 111 updates, in the same manner as described hereinabove, the ACQUISITION END TIME and LOG CONTENTS as indicated in the management information 131 depicted in FIG. 25 (S35).

More specifically, in the example depicted in FIG. 25, “2014/07/12 00:06:19” is set in the ACQUISITION END TIME and “Message 7-1” is set in the LOG CONTENTS in the information in which the MACHINE ID is “11A”. Further, “2014/07/12 00:05:31” is set in the ACQUISITION END TIME and “Message 7-2” is set in the LOG CONTENTS in the information in which the MACHINE ID is “11B”. Furthermore, “2014/07/12 00:06:12” is set in the ACQUISITION END TIME and “Message 7-3” is set in the LOG CONTENTS in the information in which the MACHINE ID is “11C”.

Then, the past log acquisition unit 113 performs the acquisition of past logs on the basis of information which has been set in the RE-ACQUISITION EXECUTION TIME in the management information 131 (S42). More specifically, the past log acquisition unit 113 calculates 0 h, 1 min, 5 sec on Jul. 12, 2014, which is the time 1 min before the time of “2014/07/12 00:02:05” which has been set in the RE-ACQUISITION EXECUTION TIME in the management information 131 depicted in FIG. 25.

The time of 0 h, 1 min, 5 sec on Jul. 12, 2014, which is the time calculated by the past log acquisition unit 113, is before the time of 0 h, 1 min, 10 sec on Jul. 12, 2014, which has been set in the RE-ACQUISITION START TIME in the management information 131 depicted in FIG. 24. Therefore, the past log acquisition unit 113 accesses the storage unit 20 and acquires the logs output over 55 sec from 0 h, 1 min, 10 sec on Jul. 12, 2014, which corresponds to the RE-ACQUISITION START TIME, to 0 h, 2 min, 5 sec on Jul. 12, 2014, among the logs output by the physical machine 11B. As a result, the past log acquisition unit 113 can prevent the acquisition of logs having the TIME STAMPS indicating the time before the time which has been set in the RE-ACQUISITION START TIME.

Then, the past log acquisition unit 113, for example, determines whether or not a physical machine for which log acquisition has been performed by going back to the RE-ACQUISITION START TIME in the management information 131 is present (S43). More specifically, in the example depicted in FIG. 25, the past log acquisition unit 113 performs log acquisition by going back to the RE-ACQUISITION START TIME. Therefore, the past log acquisition unit 113 determines that a physical machine for which log acquisition has been performed by going back to the RE-ACQUISITION START TIME in the management information 131 is present (YES in S43). Thus, the past log acquisition unit 113 determines that the acquisition of past logs of the physical machine 11B has been completed.

Then, the past log acquisition unit 113 deletes the information which has been set in the RE-ACQUISITION EXECUTION TIME and RE-ACQUISITION START TIME corresponding to the physical machine for which the acquisition of past logs has been performed until the RE-ACQUISITION START TIME in the management information 131 (S44). More specifically, as depicted in FIG. 25, the log management unit 112 deletes the information which has been set in the RE-ACQUISITION EXECUTION TIME and RE-ACQUISITION START TIME corresponding to the information in which the MACHINE ID is “11B”. As a result, the log management unit 112 can prevent the acquisition of past logs with the past log acquisition unit 113 when the log acquisition unit 111 has performed the next lot acquisition processing.

[Specific Example of Case in which Logs have been Acquired from Physical Machine for which Information is not Present in Management Information]

A specific example of the case in which logs have been acquired from a physical machine for which information is not present in the management information 131 will be explained hereinbelow.

Initially, the log acquisition unit 111 waits, for example, until the execution timing of log acquisition processing in the same manner as described hereinbelow (NO in S21). When the execution timing of the log acquisition processing is thereafter reached (YES in S21), the log acquisition unit 111, for example, refers to the management information 131 in the same manner as described hereinbelow. In the case explained herein, the log acquisition unit 111 refers to the management information 131 depicted in FIG. 25.

Then, the log acquisition unit 111 specifies the most recent TIME STAMP from among the TIME STAMPS of the logs that have been output in the past by the physical machines 11, for each physical machine 11 for which the non-acquisition flag included in the management information 131 is “0” (S22). More specifically, in the management information 131 depicted in FIG. 25, the log acquisition unit 111 specifies “2014/07/12 00:06:19”, “2014/07/12 00:05:31”, and “2014/07/12 00:06:12”, which are ACQUISITION END TIMES corresponding to the information in which the non-acquisition flag is “0”.

Then, the log acquisition unit 111, for example, acquires the log having the TIME STAMP corresponding to the time after the oldest time, among the times indicated by the most recent TIME STAMPS specified in S22 (S23). More specifically, in the management information 131 depicted in FIG. 25, the log acquisition unit 111 acquires the log having the TIME STAMP corresponding to the time after the TIME STAMP of “2014/07/12 00:05:31”.

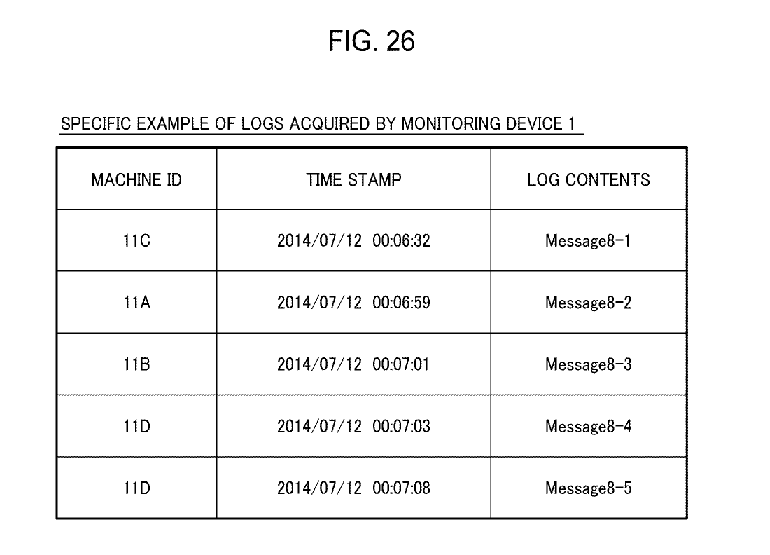

More specifically, for example, as depicted in FIG. 26, the log acquisition unit 111 acquires the log with the MACHINE ID of “11C”, the TIME STAMP of “2014/07/12 00:06:32”, and the LOG CONTENTS of “Message 8-1”. The explanation relating to other types of information in FIG. 26 is omitted. The logs depicted in FIG. 26 represent acquisition results relating to the case in which logs with the TIME STAMP from “2014/07/12 00:06:30” to “2014/07/12 00:07:29” have been acquired.

Then, by using the results of log acquisition from the storage unit 20 in S23, the log management unit 112 determines whether or not the log output from the physical machine 11 for which information is not present in the management information 131 is present (S24). More specifically, the logs depicted in FIG. 26 include a log with the MACHINE ID of “11D” of the physical machine for which information is not present in the management information 131. Therefore, the log management unit 112 determines that a log output from the physical machine 11 for which information is not present in the management information 131 is present (YES in S24). For example, the physical machine for which the MACHINE ID is “11D” corresponds to the physical machine 11D depicted in FIG. 1.

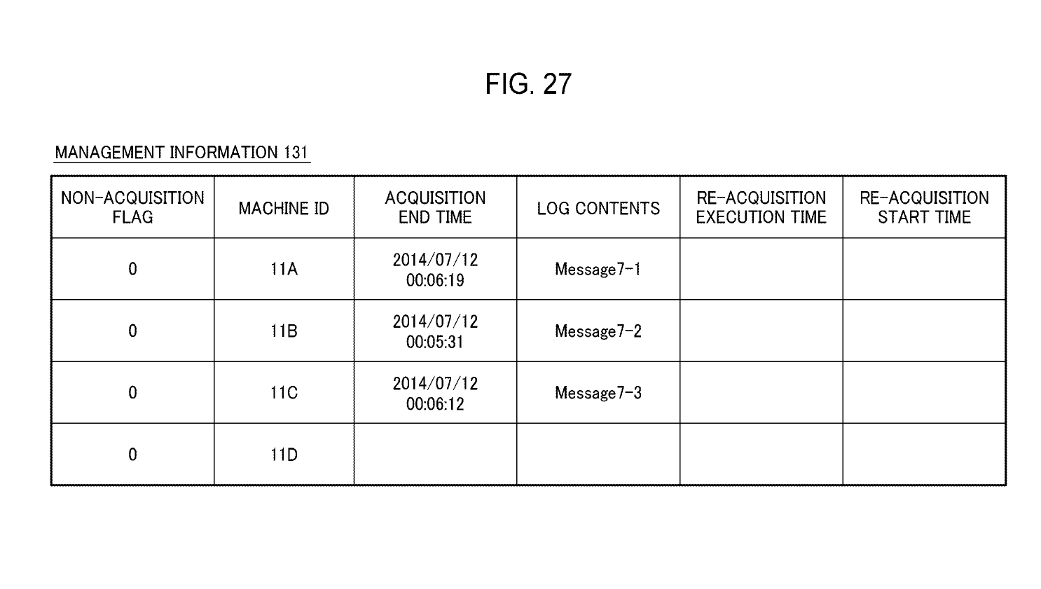

In this case, the log management unit 112, for example, adds information on the new physical machine to the management information 131 (S25). More specifically, as depicted in FIG. 27, the log management unit 112 adds information that the MACHINE ID is “11D” to the management information 131. The log management unit 112 also sets “0” as the NON-ACQUISITION FLAG, for example, as depicted in FIG. 27.

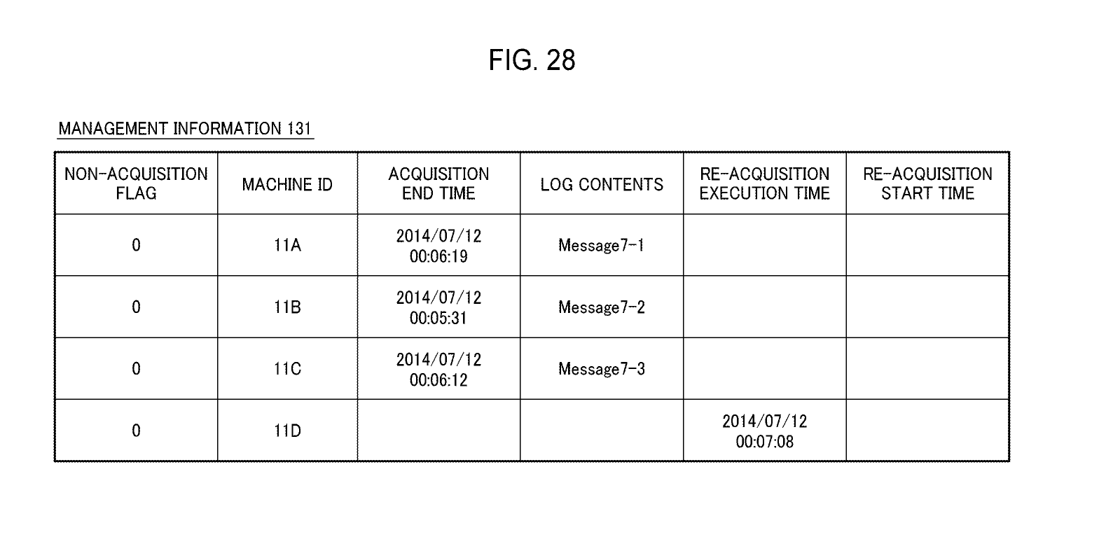

Then, the log management unit 112, for example, sets the most recent TIME STAMP, among the TIME STAMPS of the logs output by the new physical machine, as the RE-ACQUISITION EXECUTION TIME in the management information 131 (S26). More specifically, the TIME STAMPS of the logs with the MACHINE ID of “11D”, which relates to the new physical machine, among the logs depicted in FIG. 26, are “2014/07/12 00:07:03”, and “2014/07/12 00:07:08”. Therefore, as depicted in FIG. 28, the log management unit 112 sets “2014/07/12 00:07:08” as the RE-ACQUISITION EXECUTION TIME corresponding to the information in which the MACHINE ID is “11D”.

Then, by using the results of log acquisition from the storage unit 20 in S23, the log management unit 112 determines whether or not a physical machine for which a log was not able to be acquired is present among the physical machines for which the non-acquisition flag in the management information 131 is “0” (S27). More specifically, in the management information 131 depicted in FIG. 27, the information in which the NON-ACQUISITION FLAG is “0” is the MACHINE ID of “11A”, “11B”, “11C”, and “11D”. Further, the logs depicted in FIG. 26 include all of the logs for which the MACHINE ID is “11A”, “11B”, “11C”, and “11D”. Therefore, the log management unit 112 determines that a physical machine for which a log was not able to be acquired is not present among the physical machines for which the non-acquisition flag in the management information 131 is “0” (NO in S27).

Then, for example, by using the results of log acquisition from the storage unit 20 in S23, the log management unit 112 determines that the log of a physical machine for which the non-acquisition flag in the management information 131 is “1” has not been acquired (NO in S31).

Then, the log management unit 112 sets the time stamp indicating the most recent time, among the times indicated by the time stamps of the logs acquired in S23, to the acquisition end time for each physical machine (S35).

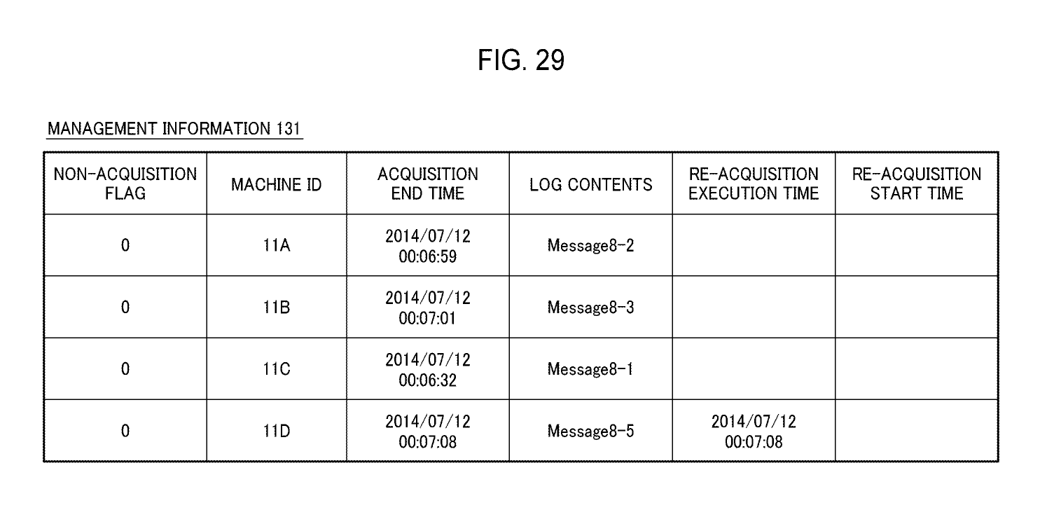

More specifically, the log management unit 112 refers to the logs depicted in FIG. 26 and updates, as depicted in FIG. 29, the management information depicted in FIG. 28. Thus, the log management unit 112 sets “2014/07/12 00:06:59” as the ACQUISITION END TIME corresponding to the information in which the MACHINE ID is “11A”, and sets “Message 8-2” in the LOG CONTENTS. The log management unit 112 also sets “2014/07/12 00:07:01” as the ACQUISITION END TIME corresponding to the information in which the MACHINE ID is “11B”, and sets “Message 8-3” in the LOG CONTENTS. Further, the log management unit 112 sets “2014/07/12 00:06:32” as the ACQUISITION END TIME corresponding to the information in which the MACHINE ID is “11C”, and sets “Message 8-1” in the LOG CONTENTS. Then, the log management unit 112 sets “2014/07/12 00:07:08” as the ACQUISITION END TIME corresponding to the information in which the MACHINE ID is “11D”, and sets “Message 8-5” in the LOG CONTENTS.

Then, the log management unit 112, for example, refers to the management information 131 depicted in FIG. 29 and determines whether or not a physical machine is present for which the RE-ACQUISITION EXECUTION TIME is not blank (S41).

More specifically, in the management information 131 depicted in FIG. 29, information has been set in the RE-ACQUISITION EXECUTION TIME corresponding to the information in which the MACHINE ID is “11D”. Therefore, the log management unit 112 determines that physical machine for which the RE-ACQUISITION EXECUTION TIME is not blank is present (YES in S41).

Then, the past log acquisition unit 113, for example, acquires logs in a period up to a unit time (for example, 1 min) before the time which has been set in the RE-ACQUISITION EXECUTION TIME, for each physical machine for which the RE-ACQUISITION EXECUTION TIME is not blank, in the same manner as described hereinabove (S42). Thus, when a log output by the new physical machine has been acquired in S23, the past log acquisition unit 113 acquires the past logs output by the new physical machine.

More specifically, the past log acquisition unit 113 calculates 0 h, 6 min, 8 sec on Jul. 12, 2014, which is 1 min before “2014/07/12 00:07:08” which has been set in the RE-ACQUISITION EXECUTION TIME in the management information 131 depicted in FIG. 29. Then, the past log acquisition unit 113 accesses the storage unit 20 and acquires the logs output over 1 min from 0 h, 6 min, 8 sec on Jul. 12, 2014 to 0 h, 7 min, 8 sec on Jul. 12, 2014, among the logs output by the physical machine 11B. In the explanation hereinbelow, it is assumed that the past log acquisition unit 113 has acquired a log output over a period from 0 h, 6 min, 8 sec on Jul. 12, 2014 to 0 h, 7 min, 8 sec on Jul. 12, 2014.

In this case, when the RE-ACQUISITION START TIME is blank, the past log acquisition unit 113 is not able to determine a range in which the past logs need to be acquired, by contrast with the case (the case described with reference to FIG. 20) in which the information has been set in the RE-ACQUISITION START TIME. Therefore, in the case in which the past log acquisition unit 113 performs the acquisition of past logs when the RE-ACQUISITION START TIME is blank, for example, the acquisition of past logs is repeated until the past logs are not able to be acquired anymore. When the past logs are not able to be acquired anymore, the past log acquisition unit 113, for example, acquires at a time the past logs having the TIME STAMPS indicating the time before the range in which the acquisition of past logs has been performed. As a result, the past log acquisition unit 113 can acquire all of the past logs while preventing the occurrence of a processing delay caused by the increase in processing load in the monitoring device 1. A specific example in which the past log acquisition unit 113 acquires at a time the past logs having the TIME STAMPS indicating the time before the range in which the acquisition of past logs has been performed will be described hereinbelow.

Then, the past log acquisition unit 113, for example, determines whether or not a physical machine is present for which log acquisition has been performed by going back to the RE-ACQUISITION START TIME in the management information 131 (S43). More specifically, in the management information 131 depicted in FIG. 29, the RE-ACQUISITION START TIME is blank. Therefore, the past log acquisition unit 113 determines that a physical machine for which log acquisition has been performed by going back to the RE-ACQUISITION START TIME in the management information 131 is not present (NO in S43).

Then, the past log acquisition unit 113, for example, determines whether or not a physical machine for which past logs were not able to be acquired is present among the physical machines for which the RE-ACQUISITION START TIME in the management information 131 is blank (S45). More specifically, in the management information 131 depicted in FIG. 29, the past log acquisition unit 113 has acquired the logs output over a period from 0 h, 6 min, 8 sec on Jul. 12, 2014 to 0 h, 7 min, 8 sec on Jul. 12, 2014, as described hereinabove. Therefore, the past log acquisition unit 113, for example, determines that a physical machine for which the past logs were not able to be acquired is not present among the physical machines for which the RE-ACQUISITION START TIME in the management information 131 is blank (NO in S45).

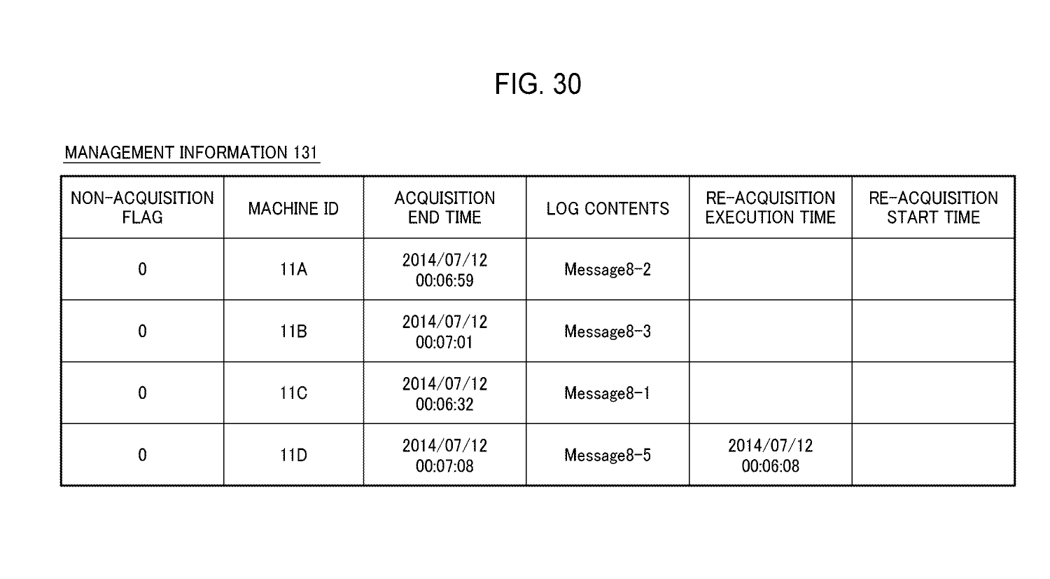

Then, the log management unit 112 sets, as the RE-ACQUISITION EXECUTION TIME, the time which is by a unit time before the time which has been set in the RE-ACQUISITION EXECUTION TIME, with respect to the physical machines for which information has been set in the RE-ACQUISITION EXECUTION TIME of the management information 131 (S48). More specifically, as depicted in FIG. 30, the log management unit 112 resets “2014/07/12 00:06:08” indicating the time which is 1 min before “2014/07/12 00:07:08”, which is the time stamp that has been set in the RE-ACQUISITION EXECUTION TIME, in the RE-ACQUISITION EXECUTION TIME. The log acquisition unit 111 then waits again until the log acquisition timing (S21).

[Specific Example of Case in which Acquisition of Past Logs is Performed]

A specific example of the case in which the acquisition of past logs is performed will be explained hereinbelow with respect to the example of the management information 131 depicted in FIG. 30. The explanation of features which have already been explained hereinabove will be hereinbelow omitted as appropriate.

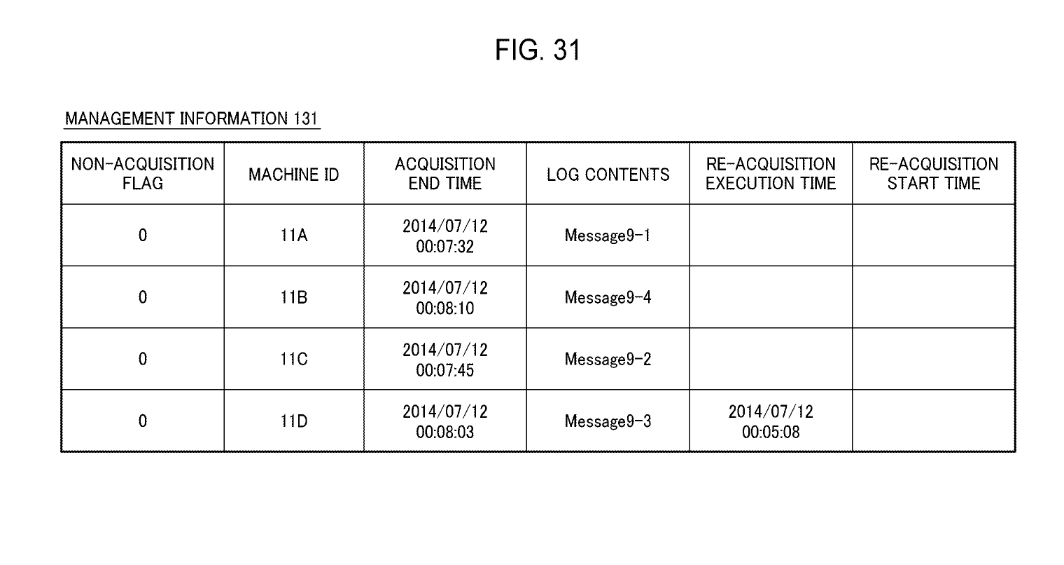

When the log acquisition unit 111 performs the next log acquisition processing in the example illustrated by the management information 131 depicted in FIG. 30 (S23), the log acquisition unit 111 updates the ACQUISITION END TIME and LOG CONTENTS, in the same manner as described hereinabove, as illustrated by the management information 131 depicted in FIG. 31 (S35).

More specifically, in the example depicted in FIG. 31, in the information in which the MACHINE ID is “11A”, “2014/07/12 00:07:32” is set in the ACQUISITION END TIME and “Message 9-1” is set in the LOG CONTENTS. Further, in the information in which the MACHINE ID is “11B”, “2014/07/12 00:08:10” is set in the ACQUISITION END TIME and “Message 9-4” is set in the LOG CONTENTS. In the information in which the MACHINE ID is “11C”, “2014/07/12 00:07:45” is set in the ACQUISITION END TIME and “Message 9-2” is set in the LOG CONTENTS. Further, in the information in which the MACHINE ID is “11D”, “2014/07/12 00:08:03” is set in the ACQUISITION END TIME and “Message 9-3” is set in the LOG CONTENTS.

Then, the past log acquisition unit 113 performs the acquisition of past logs on the basis of the information which has been set in the RE-ACQUISITION EXECUTION TIME in the management information 131 (S42). More specifically, the past log acquisition unit 113 calculates 0 h, 5 min, 8 sec on Jul. 12, 2014, which is 1 min before “2014/07/12 00:06:08” which has been set in the RE-ACQUISITION EXECUTION TIME in FIG. 30. Then, the past log acquisition unit 113 accesses the storage unit 20 and acquires the logs output over 1 min from 0 h, 5 min, 8 sec on Jul. 12, 2014 to 0 h, 6 min, 8 sec on Jul. 12, 2014, among the logs output by the physical machine 11B. In the explanation hereinbelow, it is assumed that the past log acquisition unit 113 was not able to acquire a log output over a period from 0 h, 5 min, 8 sec on Jul. 12, 2014 to 0 h, 6 min, 8 sec on Jul. 12, 2014.

Then, the past log acquisition unit 113, for example, determines whether or not a physical machine for which past logs were not able to be acquired is present among the physical machines for which the RE-ACQUISITION START TIME in the management information 131 is blank (S45). More specifically, in the example depicted in FIG. 31, the past log acquisition unit 113 has not acquired the logs output from 0 h, 5 min, 8 sec on Jul. 12, 2014, to 0 h, 6 min, 8 sec on Jul. 12, 2014, as described hereinabove. Therefore, the past log acquisition unit 113, for example, determines that a physical machine for which the past logs were not able to be acquired is not present among the physical machines for which the RE-ACQUISITION START TIME in the management information 131 is blank (NO in S45).

In this case, the past log acquisition unit 113, for example, acquires all of the logs having the TIME STAMP indicating a time before the time which has been set in the RE-ACQUISITION EXECUTION TIME in the management information 131, among the logs output by the physical machine for which the RE-ACQUISITION START TIME in the management information 131 is blank (S46). More specifically, in the example depicted in FIG. 31, the past log acquisition unit 113, for example, acquires all of the logs having the TIME STAMP indicating a time before 0 h, 5 min, 8 sec on Jul. 12, 2014, which has been acquisition time in S42.

Thus, when past logs were not able to be acquired in S42, it can be predicted that the number of past logs having the TIME STAMP indicating a time before the time at which the acquisition of past logs has been performed in S42 is small. Therefore, in this case, the past log acquisition unit 113 acquires, at a time, the past logs preceding the time of acquisition in S42.

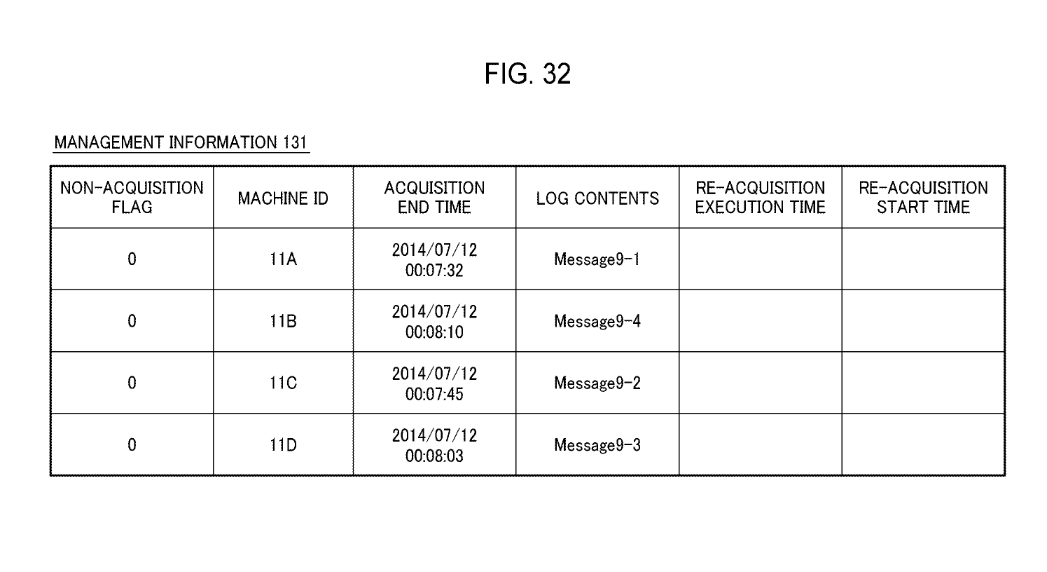

Then, the past log acquisition unit 113 deletes the information which has been set in the RE-ACQUISITION EXECUTION TIME and RE-ACQUISITION START TIME corresponding to the physical machine for which the acquisition of past logs has been performed until the RE-ACQUISITION START TIME in the management information 131 (S47). More specifically, the log management unit 112 deletes the information which has been set in the RE-ACQUISITION EXECUTION TIME and RE-ACQUISITION START TIME corresponding to the information in which the MACHINE ID, for which the past log acquisition unit 113 has performed the acquisition of past logs, is “11D”, as depicted in FIG. 32. As a result, the log management unit 112 can prevent the acquisition of past logs with the past log acquisition unit 113 when the log acquisition unit 111 has performed the next log acquisition processing.

Thus, according to the first embodiment, when a log has not been acquired from the first physical machine during the execution of the first log acquisition processing, the monitoring device 1 stores the identification information on the first physical machine and the information to the effect that the log has not been acquired in association with each other in the first storage section. When a log is acquired from the first physical machine during the execution of the second log acquisition processing, which is new log acquisition processing, the monitoring device 1 also acquires a log of a period preceding the log acquisition target period of the second log acquisition processing from the first machine. As a result, the monitoring device 1 can prevent the occurrence of a log acquisition failure with respect to logs output from a plurality of physical machines.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing therein a log acquisition management program for causing a computer to execute a process comprising:
storing, in a first storage, identification information on first information processing device included in a plurality of information processing devices that are used for execution of a single application, in association with information indicating that a log has not been acquired, when executing first log acquisition processing and when the log has not been acquired from the first information processing device, the first log acquisition processing being a processing acquiring logs from the plurality of information processing devices and collecting the acquired logs in a second storage; and
when executing second log acquisition processing, which is new log acquisition processing, after the first log acquisition processing has been executed, and when a log has been acquired from the first information processing device, acquiring also a log of a past period preceding a log acquisition target period of the second log acquisition processing from the first information processing device.

2. The non-transitory computer-readable storage medium according to claim 1, wherein
the storing includes, when a log has been acquired from the first information processing device during the executing the first log acquisition processing, storing, in the first storage, the identification information on the first information processing device in association with the information indicating that the log has been acquired.

3. The non-transitory computer-readable storage medium according to claim 1, further comprising when a log has been acquired from an information processing device included in the plurality of information processing devices, storing, in the first storage, a time stamp indicating a time at which the acquired log has been output in association with identification information on the information processing device which has output the acquired log, wherein
the past period is a period before a time indicated by the most recent time stamp among the time stamps corresponding to the first information processing device stored in the second storage.

4. The non-transitory computer-readable storage medium according to claim 3, wherein
in the first and second log acquisition processing, when an information processing device for which identification information has been stored in the first storage in association with the information indicating that a log has not been acquired is not present, the most recent time stamp among the time stamps stored in the first storage is specified and a log having a time stamp corresponding to a time after the oldest time among the times indicated by the specified time stamp is acquired for each information processing device for which the identification information has been stored in the first storage, and when an information processing device for which identification information has been stored in the first storage in association with the information indicating that a log has not been acquired is present, the most recent time stamp among the time stamps stored in the first storage is specified and a log having a time stamp corresponding to a time after the oldest time among the times indicated by the specified time stamp is acquired for each information processing device other than the information processing device for which the identification information has been stored in the first storage in association with the information indicating that a log has not been acquired.

5. The non-transitory computer-readable storage medium according to claim 3, wherein
the acquiring includes:
when a log is acquired from the first information processing device during the executing the second log acquisition processing, logs in a period up to a unit time before the time stamp of the acquired log are also acquired from the first information processing device, and
each time new log acquisition processing is executed after the second log acquisition processing has been executed, logs in periods going back by the unit time from before the unit time are also acquired until the time indicated by the time stamp corresponding to the acquired log becomes the time indicated by the most recent time stamp.

6. The non-transitory computer-readable storage medium according to claim 1, wherein
the acquiring includes:
when a log has been acquired from a new information processing device for which the identification information has not been stored in the first storage among the plurality of information processing devices, logs in a period up to a unit time before the time stamp of the acquired log are also acquired from the new information processing device, and
each time new log acquisition processing is executed after the second log acquisition processing has been executed, logs in periods going back by the unit time from before the unit time are also acquired until logs from the new information processing device are not able to be acquired anymore.

7. A log acquisition management device, comprising:
a first storage that, when executing first log acquisition processing of acquiring logs from a plurality of information processing devices that are used for execution of a single application and of collecting the acquired logs in a second storage, and when a log has not been acquired from a first information processing device included in the plurality of information processing devices, stores identification information on the first information processing device in association with information indicating that the log has not been acquired; and
a processor that, when executing second log acquisition processing, which is new log acquisition processing, after the first log acquisition processing has been executed, and when a log has been acquired from the first information processing device, acquires also a log of a past period preceding a log acquisition target period of the second log acquisition processing from the first information processing device.

8. A log acquisition management method comprising:
storing, by a processor, in a first storage, identification information on first information processing device included in a plurality of information processing devices that are used for execution of a single application, in association with information indicating that a log has not been acquired, when executing first log acquisition processing and when the log has not been acquired from the first information processing device, the first log acquisition processing being a processing acquiring logs from the plurality of information processing devices and collecting the acquired logs in a second storage; and
when executing second log acquisition processing, which is new log acquisition processing, after the first log acquisition processing has been executed, and when a log has been acquired from the first information processing device, acquiring, by a processor, also a log of a past period preceding a log acquisition target period of the second log acquisition processing from the first information processing device.
